(19) United States
(12) Patent Application Publication
(10) Pub. No.: US 2006/0263753 A1
(43) Pub. Date: Nov. 23, 2006

(54) Method of reasoning mode identification and assessment

(76) Inventor: Regina Marie Hoffman, Palo Alto, CA (US)

Correspondence Address: PATRICK REILLY, BOX 7218, SANTA CRUZ, CA, 95061-7218, US

(21) Appl. No.: 11/135,847

(22) Filed: May 23, 2005

(51) Int. Cl. G09B 19/00

(52) U.S. Cl. 434/236

(57) ABSTRACT

A method for identifying reasoning modes and assessing the relative preference of a reasoning mode of a test subject (“investigator”). More specifically, dichotomous pairs of terms are developed wherein each pair contains one term predominantly associated with a linear reasoning mode, and another term predominantly associated with a complexity reasoning mode. The pairs of terms are presented to the investigator for selection by the investigator as to which of the two terms of each term pair best describes, in the judgment of the investigator, the investigator's reasoning behavior. New terms may be tested for psychometric strength against the empirical record of a plurality of previously employed terms. Words and images may be compared to a library of terms to form new terms whose suitability as terms associated with a distinct reasoning mode is then evaluated. The identification of reasoning modes may include a method for assessing the association of a mental capacity with a reasoning mode. Problems may be abstracted and compared with a library of models to determine which reasoning mode is most appropriate for use in addressing each problem. Certain words describing dichotomous qualities and aspects of linear reasoning and complexity reasoning modes are provided.

### FIELD OF THE INVENTION

The Present Invention relates to the field of problem solving cognition and personality assessment. More specifically, the Present Invention relates to the identification of reasoning modes in cognition and to the assessment of reasoning behavior.

### BACKGROUND OF THE INVENTION

Human beings have a long tradition of seeking to define, distinguish and understand the modes and differences in cognitive behavior evident among mentally healthy and functional human beings. This historical curiosity is expressed in branches of psychology and medicine concerned with defining and measuring certain characteristics of human behavior, personality, cognitive abilities, interests, and aptitudes. In the European intellectual tradition, we find attempts to systematize these differences in Hippocrates work of the fifth century B.C.E. Hippocrates described four temperaments, or humors, the interaction and effects of which he believed determined an individual's emotional and physical state. These humors were identified by Hippocrates and his colleagues as: blood, phlegm, yellow bile, and black bile. The four humor theory taught that an ideal state of an individual would be achieved when the individual's four humors were in proper balance. Variations in the balances among the humors of each person could, according to the four humor model, be the root cause of variations of mental activity found among human beings.

In the 1920s the psychiatrist Carl Jung published a theory of psychological type in an attempt to explain the differences in personality generally found among psychologically healthy people. It is understood that Jung wrote primarily in the German language, and that the Jungian terms employed within this disclosure comprise the descriptive words established and used within the art as Jungian terminology expressed in the English language. Jung hypothesized that the observable and self-reported differences in individual cognitive behavior emanated from variations of three distinguishable aspects of the mental function of each human subject. He defined these three most significant aspects of human mental activity as (a) psychological energy orientation, (b) perception, and (c) reasoning. Jung further identified, for each of these aspects of mental function, a unique pair of dichotomous modes that he believed operated within the specific realms of the relevant aspect. Jung taught that the differences of individual personalities are largely generated by each person's unique patterns of instantiation, prevalence and interplay of these dichotomous mode pairs of each of the three key aspects of mental function.

Jung identified extraversion and introversion as a dichotomous pair of modes operating within the orientation of psychological energy of each mentally healthy human being. The term “dichotomous mode” is defined within this disclosure as indicating that the instantiation of a first mode limits or precludes the presence or embodiment of a second mode within the context of an identified aspect of mental function. It is understood that a pair of dichotomous modes comprises a first mode and a second mode that are mutually dichotomous, and that each mode of the dichotomous pair may be instantiated within the context of an aspect of a same mental function.

Jung also identified sensing and intuiting as two mutually dichotomous modes of cognitive behavior applicable or operable within the mental functional aspect of perception. The term perception is defined within this disclosure to include the human mental processes, or an element of a mental process, of detecting, noticing, registering, capturing, accepting, receiving, relating, and taking in information. Perception may occur on conscious, preconscious and unconscious levels of mental activity.

Jung further posited the existence of a pair of dichotomous modes of reasoning mode behavior, to include rational decision-making, related to the mental functional aspect of reasoning. He identified the reasoning mode pair as thinking and feeling, which he labeled as judging activities.

The term reasoning is defined within this disclosure to include the human mental processes, or an element of a mental process of organizing, sorting, arranging, examining, analyzing, evaluating, interpreting, concluding, or any form of discerning or imposing order on data as the basis for rational decision making. Reasoning may occur on conscious, preconscious and unconscious levels of mental activity.

Jung further maintained that, for all intents and purposes, every mentally healthy person regularly uses all six of these mental modes of cognitive behavior. In partial analogy with the four humor model of Hippocrates, he asserted that the relative occurrence and intensity of instantiation of each cognitive behavior mode, and in relation to its paired mode, influences the generation, strength and pattern of the personality characteristics that Jung called psychological type.

Jung's theory spearheaded a field of practice in which cognitive processes and behaviors are examined, characterized, categorized, and assessed through the perspective of psychological type. A proliferation of practical applications based on Jung's type theory have entered the marketplace, as per this compilation of prior art:
1) Psychological Instruments. The publication in 1962 of the Myers-Briggs Type Indicator® (hereafter “MBTI®”) personality type indication instrument provided an important step in transforming Jung's theory of psychological type into practical application. The MBTI® is used by over 3 million people annually and has been translated into 16 languages. The MBTI® has been followed by other psychological instruments that credit Jung's theory as their source. A profitable, worldwide business practice now exists that provides the creation, validation, publication, distribution, research, application, and psychometric evaluation of psychological instruments based on Jung's theory of psychological type.
2) Educational. Using Jung's theory of psychological type as a springboard, a substantial body of educational materials has been developed to foster personal growth and development. Other goals for such materials are mutual understanding of personality differences in interpersonal, business, community, and multi-cultural settings. These materials include but are not limited to published matter, educational games, individual feedback guidelines, computer-generated reports, and group workshops.
3) Qualification Training and Assessment. The administration of most psychometric tests requires the judgment and supervision of one or more professionals having specific knowledge, capabilities and qualifications. A worldwide network of training professionals offers test counselors and proctors training necessary to administer and optimally apply certain “psychological type” instruments.
4) Temperament Applications. Jung's theory of psychological type represented a new method of linking psychological temperament to normal mental function. Some practical applications of the prior art emphasize the expected consequences to personal temperament that follow from the relative dominance of specific cognitive behavior.
5) Career Counseling/Coaching. A large amount of research has found a correspondence between psychological type and career choices/career satisfaction. As a result, career counseling/coaching is another practical application of psychological type.
6) Health and Well-Being. Some practical applications of the prior art emphasize the hazards to health that are likely to occur when individuals work against their natural psychological type. This phenomenon is called “falsification of type.” Jung's theory does not claim that one's skill development is constrained by one's type. However, it does suggest that it takes more energy to use mental functions that are not dominant in one's type.
7) Skill Development. Jung set the stage for describing the skills required by each of four modes of cognitive behavior (the two perceiving modes and the two reasoning modes). Those who have transformed his theory into practical applications have expanded those skill descriptions and skill assessment measures. The field of skill development and skill assessment in normal mental function is influenced by Jung psychological type theory.

There has been general agreement for many centuries that one mode of reasoning in normal mental function conforms to classic linear principles while another mode does not. One of Jung's pivotal contributions was his characterization that both reasoning modes are rational and healthy in normal mental function.

Little progress has been made in exploring the nature of the non-linear reasoning mode since Jung's discovery of its role in human mental activity. The actual nature of the non-linear reasoning has remained shrouded in mystery. This failure of the prior art is especially evident in comparison with the clarity with which the operational processes of the linear reasoning mode are depicted. Jung and other researchers in this field of practice have apparently failed to decipher and explicate the logical structure of the non-linear reasoning mode. The prior art's limitation in substantively defining, describing or identifying the non-linear reasoning mode has hampered the individual's and society's capacity to recognize, acknowledge, respect and harness this powerful and fundamental element of human potential.

Scientific researchers familiar with the Western logical reasoning tradition have recently proposed the existence of two ubiquitous regimes of order, each with its own distinct logic and analytic requirements. Only one of these regimes of order conforms to classic linear principles. A large number of problems persist in the field of practice because of the failure to describe qualities of the logical structure of a non-linear reasoning mode. This failure coupled with a mistaken belief that only a linear reasoning mode is logical seriously impairs the quality of prior art. These problems, and the ways that the Present Invention addresses unmet needs of identifying, distinguishing and assessing human reasoning behavior, are discussed below. There is therefore a long felt need to provide a method and instrument useful in the self-identification and assessment of reasoning activity.

### SUMMARY OF THE INVENTION

Towards these objects, and other objects that will be made apparent in light of the present disclosure, a method and system for supporting assessment of reasoning behavior is provided. This and other objects of the Present Invention will no doubt become obvious to those of ordinary skill in the art after having read the following summary and detailed description of preferred embodiments and viewing the figures illustrating the preferred embodiments.

A first preferred Method of the Present Invention, or first Method, includes enabling an investigator to self indicate a reasoning mode behavior by (a) selecting a pair of terms having a first term and a second term, the first term associated with linear reasoning and the second term associated with complexity reasoning, (b) presenting the pair of terms to the investigator, and (c) enabling the investigator to choose either the first term or the second term as being more descriptive of the investigator's reasoning mode behavior, whereby the mode of reasoning associated with the selected term indicates the investigator's dominant reasoning mode. Linear reasoning is the rational mode that substantially satisfies the analytic requirements of the linear order found in mechanical systems. Linear reasoning terms are often appropriate for describing and/or useful in modeling linear systems. Complexity reasoning is the rational mode that substantially satisfies the analytic requirements of the complexity order found in living systems. Complexity reasoning terms are often appropriate for describing and/or useful in modeling complex adaptive systems.

It is understood that the descriptive terminology of “first” and “second” is defined in this disclosure to distinguish terms within a pair, and is not indicative of the temporal or physical order, placement or position of a term within a presentation of a pair of terms to the investigator.

It is further understood that a term may be or comprise one or more human language words expressed in visual alphabetic representations or ideograms, e.g. words expressed in the Roman alphabet, Cyrillic alphabet, Arabic alphabet, or Chinese characters. In certain alternate preferred embodiments of the Present Invention, terms may be expressed as vocalizations of one or more human language words, sounds, Braille and/or other suitable sensory images known in the art.

The terms may be presented to the investigator in various alternate preferred Methods of the Present Invention by means of printed media, visual projection, electronic video screens, and/or suitable sensory output devices known in the art. Examples of suitable sensory output devices include DVD players, phonographs, and laser light projectors.

The first version may optionally further comprise (d) selecting a plurality of pairs of terms, each pair of terms having a first term associated with linear reasoning and a second term associated with complexity reasoning, (e) presenting the plurality of pairs of terms to the investigator, and (c) enabling the investigator to choose either the first term or the second term of each pair of terms as being more descriptive of the investigator's reasoning mode behavior, whereby the relative quantities of selected first terms and selected second terms indicates the investigator's dominant reasoning mode.

In certain still alternate preferred Methods of the Present Invention, at least one term is weighted in relationship to at least one other term, and the relative weighted and summed scores of the selected first terms and the selected second terms indicates the investigator's dominant reasoning mode.

In certain yet alternate preferred embodiments of the Present Invention may incorporate one or more of the following:
communicating descriptions of both reasoning modes as well as the mode of reasoning associated with a selected term to the investigator, whereby the investigator may consider the significance of the term selection;
communicating descriptions of both reasoning modes as well as the mode of reasoning associated with the majority of selected terms is communicated to the investigator, whereby the investigator may consider the significance of the term selections;
communicating to the investigator descriptions of both reasoning modes as well as the mode of reasoning associated with relative quantities of selected first terms and selected second terms and/or the mode of reasoning associated with each of the first terms and the second terms, whereby the investigator may consider the significance of the term selections;
communicating to the investigator descriptions of both reasoning modes as well as the mode of reasoning associated with the majority of selected terms, whereby the investigator may consider the significance of the term selections;
a process of (a) documenting the results of a plurality of instances of multiple investigators choices of terms from the plurality of pair terms, (b) presenting a provisional pair of terms to the investigators, (c) documenting the choices of terms of the provisional pair of terms by the investigators, and (d) correlating the validity of term choices of the provisional pair of terms by the investigators to the documented results of the plurality of instances of step a. adding a provisional pair of terms to the plurality of pairs of terms when the correlated validity of the term choices of the provisional pair of terms by the investigators exceeds a statistical value; and
at least one term selected from a pair of terms is an image selected from the group of images comprising a visual image, a pictograph, a color, a pattern of color, a sound, a dynamic image, and a sensory image.

The first version may optionally provide for the generation of a plurality of dichotomous pairs of terms, where each pair of terms has a first term and a second term, the first term associated with linear reasoning and the second term associated with complexity reasoning. The first version may comprise one or more of the following:
generating a first list of candidate first terms, the first list of candidate first terms comprising a plurality of candidate first terms, each candidate first term describing a quality or an aspect of linear reasoning;
generating a second list of candidate second terms, the second list of candidate second terms comprising a plurality of candidate second terms, each candidate second term describing a quality or an aspect of complexity reasoning;
determining if each candidate first term forms a dichotomous pair of terms with each candidate second term;
recording each determination of a dichotomous pair of terms, whereby the candidate first term and the candidate second term of each identified dichotomous pair are associated and documented;
enabling the investigator to choose either a candidate first term or a candidate second term of a same dichotomous pair as being more descriptive of the investigator's reasoning mode behavior, whereby the mode of reasoning associated with the selected term indicates the investigator's dominant reasoning mode; and
selecting a plurality of dichotomous pairs of terms, each pair of terms having a candidate first term associated with linear reasoning and a candidate second term associated with complexity reasoning, presenting the plurality of dichotomous pairs of terms to the investigator, and enabling the investigator to choose either the candidate first term or the second candidate term of each dichotomous pair of terms as being more descriptive of the investigator's reasoning mode behavior, whereby the relative quantities of selected candidate first terms and selected candidate second terms indicates the investigator's dominant reasoning mode.

A second alternate preferred embodiment of the Method of the Present Invention, or second version, includes identifying and discovering terms associated with a reasoning mode, where each term includes a description of at least one quality or aspect of either a linear reasoning mode or a complexity reasoning mode. The second version may comprise one or more of the following:
generating a list of terms defined as mental capacities;
determining if each term is associated with a linear reasoning mode;
determining if each term is associated with a complexity reasoning mode;
identifying each term associated with the linear reasoning mode and not associated with the complexity reasoning mode as a linear reasoning capacity term;
identifying each term associated with the complexity reasoning mode and not associated with the linear reasoning mode as a complexity reasoning capacity term;
including one or more terms of the list of terms describing one or more qualities or aspects of relational positioning mapping; and
including at least one term in the list of terms that describes a quality or aspect of a homeodynamic diagnostic.

A third alternate preferred embodiment of the Present Invention, or third version, for determining when a complexity reasoning analysis or a linear reasoning analysis is more appropriate for analysis of a problem description. The third version may include one or more of the following:
determining if the problem description matches any of a library of linear systems;
determining if the problem description matches at least one of a library of linear systems and if the problem description is subject to a relationship of a subset or element of a complexity system;
determining if the problem description matches any of a library of complexity systems;
identifying a problem matching at least one of a library of linear systems, wherein the problem description is not subject to a relationship of an element or subset of a complexity system, as more appropriate for a linear reasoning analysis;
identifying a problem matching at least one of a library of linear systems, wherein the problem description is subject to a relationship of an element or subset of a complexity system, as more appropriate for a complexity reasoning analysis;
identifying a problem matching at least one of a library of complexity systems as more appropriate for a complexity reasoning analysis; and
including at least one complexity system in the library of complexity systems that comprises the behavior of a living organism.

Certain additional preferred embodiments of the Method of the Present Invention neither force nor request a choice between dichotomous pairs. Other suitable presentation formats known in the art may be applied within the scope of the Claims. For example, one format might be the presentation of a plurality of problem descriptions where one or more description is accompanied by more than two response options. A subset of the options might represent or relate to linear reasoning responses to the problem and another subset of the options could represent or relate to complexity reasoning responses to the problem. An investigator is asked to select the choices that best represent their reasoning preferences. At the completion of the presentation, the investigator is provided information about the proportion of complexity and linear reasoning mode choices they made as well as a full exposition of the two reasoning modes. Alternatively, an investigator could be asked to respond to a specific problem without being given prompting choices. After writing or vocalizing a response, the investigator is presented with a series of questions to use in the assessment of their response to determine whether the response followed linear or complexity logic, or expressed ideation generated by thinking about the problem description in terminology that is more closely associated with either complexity reasoning or linear reasoning. An exposition of the two reasoning modes is then presented to the investigator.

Certain yet additional preferred embodiments of the Method of the Present Invention provide computational systems that apply the complexity reasoning mode in the modeling, developing, and managing of complex adaptive systems. In certain yet other additional preferred embodiments of the Method of the Present Invention the investigator is provided with a combined plurality of terms where the combined plurality of terms includes (i.) a plurality of complex adaptive system modeling terms, and (ii.) a plurality of linear system modeling terms. The investigator selects terms from the combined plurality of terms that represent the assumptions that the investigator typically makes and/or the methods the investigator typically uses when trying to figure out a system, and reports the selected terms to a test proctor. It is understood that the term to “figure out” as defined within this disclosure includes the meanings of to build a mental model, to understand and to comprehend, and to attempt to build a mental model, to understand, and to comprehend. The test proctor receives the selected terms from the investigator and determines the relative quantities of selected terms from (i) the plurality of complex adaptive system modeling terms, and (ii.) the plurality of linear system modeling terms. The proctor may then optionally inform the investigator if the investigator has selected more terms from either the plurality of complex adaptive system modeling terms or the plurality of linear system modeling terms. The proctor may further optionally present the investigator with the description of the complexity reasoning mode and the description of the linear reasoning mode.

Accordingly, it is a principal object of the Present Invention to provide a method to enable an investigator to select terms associated with a reasoning mode as descriptive of or relevant to the investigator's reasoning behavior.

It is an optional object of the Present Invention to provide terms to the investigator that are associated with either linear reasoning or complexity reasoning. It is another optional object of the Present Invention to provide term pairs to the investigator, where a first term is associated with a reasoning mode and a second term is associated with another reasoning mode.

It is still another object of certain alternate preferred embodiments of the Present Invention to provide a method to select terms that are descriptive of, or relevant to, a cognitive mode.

It is an additional optional object of certain still other alternate preferred embodiments of the Present Invention to provide a method to determine a more appropriate cognitive behavior in relationship to addressing a problem or problem description.

The foregoing and other objects, features and advantages will be apparent from the following description of the preferred embodiment of the Present Invention as illustrated in the accompanying drawings.

### BRIEF DESCRIPTION OF THE DRAWINGS

These, and further features of the Present Invention, may be better understood with reference to the accompanying specification and drawings depicting the preferred embodiment, in which:

FIG. 1 is a flow chart of a first preferred embodiment of the Method of the Present Invention, or first version;

FIG. 2 is a detailed flow chart of a method of creating an expanded candidate pair list of terms that may optionally be included in the first version of FIG. 1;

FIG. 2A is a representation of an input file A of terms associated with or descriptive of linear logic and linear analytic tools that may be input into the optional expanded candidate pair creation of the first version of FIGS. 1 and 2;

FIG. 2B is a representation of an input file B of terms associated with or descriptive of complexity logic and complexity analytic tools that may be input into the optional expanded candidate pair creation of the first version of FIGS. 1 and 2;

FIG. 2C is a representation of a list of candidate pairs of terms generated by the optional expanded candidate pair creation process of the first version of FIGS. 1 and 2 and with the input file A of FIG. 2A and input file B of FIG. 2B;

FIGS. 2D.1, 2D.2, 2D.3, 2D.4, 2D.5, and 2D.6, hereafter “FIG. 2D”, in combination comprise a representation of an expanded list of candidate pairs of terms generated by the optional expanded candidate pair creation process of the first version of FIGS. 1 and 2 and with the input file A of FIG. 2A and input file B of FIG. 2B and additional lists of candidate terms;

FIG. 3 is a flow chart of the creation of a candidate test instrument in accordance with the first version of FIGS. 1, 2, 2A, 2B, 2C and 2D;

FIG. 4 is a process chart of an administration and evaluation of a candidate test instrument developed in accordance with the first version of FIG. 1;

FIG. 4A is a description of two distinct reasoning modes of linear reasoning and complexity reasoning used in the process of FIG. 4;

FIG. 5 is a flowchart of a second preferred alternate embodiment of the Method of the Present Invention, hereafter “second version”, wherein mental capacities are associated with the linear reasoning mode and/or the complexity reasoning mode;

FIGS. 5A.1 and 5A.2, hereafter “FIG. 5A”, is a representation of a list of terms describing, indicating or evoking mental capacities, and certain logical and analytic properties of each mental capacity, that may comprise an input file C of the second version of FIG. 5, whereby the list of terms of FIG. 5A may be analyzed in relationship to the input file A of FIG. 2A and the input file B of FIG. 2B in accordance with the second version of FIG. 5;

FIG. 5B is a listing of linear reasoning capacities used in the process of FIG. 5;

FIG. 5C is a listing of complexity reasoning capacities used in the process of FIG. 5;

FIG. 5D is a blank listing to be used in listing reasoning capacities not assigned to either linear reasoning mode nor complexity reasoning mode in the process of FIG. 5:

FIG. 6 is a flow chart of a third preferred embodiment of the Method of the Present Invention, or third version, wherein a problem or problem description may be examined to determine the more appropriate reasoning mode for use in generating one or more possible solutions or outcomes to the problem or problem description;

FIG. 6A is a listing of systems having linear order, where the listing is an input of the process of FIG. 6;

FIG. 6B is a listing of systems having complexity order, where the listing is an input of the process of FIG. 6;

FIG. 7 is a flow chart of a fourth preferred embodiment of the Method of the Present Invention, or fourth version, or “Embodiment D”, wherein linear system modeling terms and complex adaptive system modeling terms are presented to the investigator for selection;

FIG. 8A is a plurality of linear system modeling terms from which terms are accessed for presentation in the fourth version of FIG. 7;

FIG. 8B is a plurality of complex adaptive system modeling terms from which terms are accessed for presentation in the fourth version of FIG. 7;

FIG. 9 illustrates a communications network of an alternate preferred embodiment of the Present Invention, or first system, wherein software encoded instructions enable the interaction of the investigator with a computational device to generate responses and selections of the investigator that are indicative of the investigator's reasoning mode preferences;

FIG. 10 presents a flow chart of a fifth alternate preferred embodiment of the Method of the Present Invention, or “Embodiment E” that may be implemented by means of the first system of FIG. 9;

FIG. 11 presents a flow chart of a sixth alternate preferred embodiment of the Method of the Present Invention, or “Embodiment F” that may be implemented by means of the first system of FIG. 9; and

FIG. 12 is a representation of a display of pairs of terms of the sixth alternate preferred embodiment of FIG. 11, wherein the pairs of terms of the sixth alternate preferred embodiment of the Method of the Present Invention are presented in a printed media.

### DETAILED DESCRIPTION OF PREFERRED EMBODIMENTS

The following description is provided to enable any person skilled in the art to make and use the Present Invention and sets forth the best modes contemplated by the inventor of carrying out her Invention. Various modifications, however, will remain readily apparent to those skilled in the art, since the generic principles of the Present Invention have been defined herein.

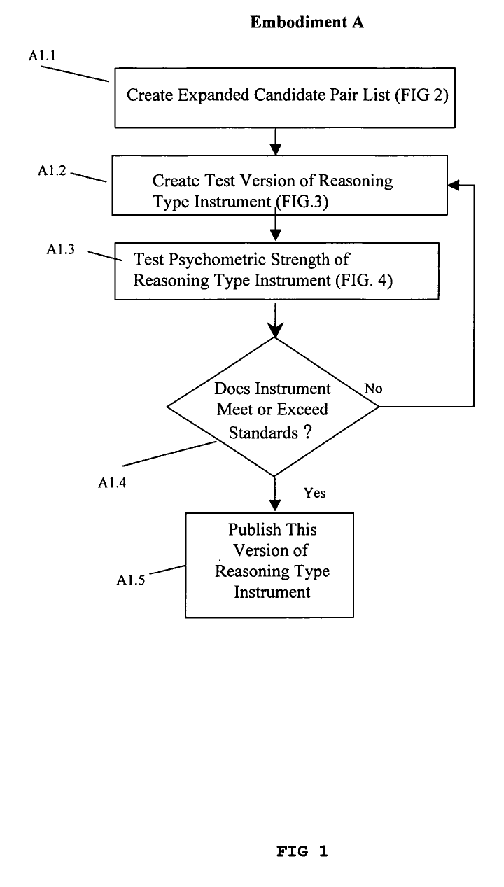

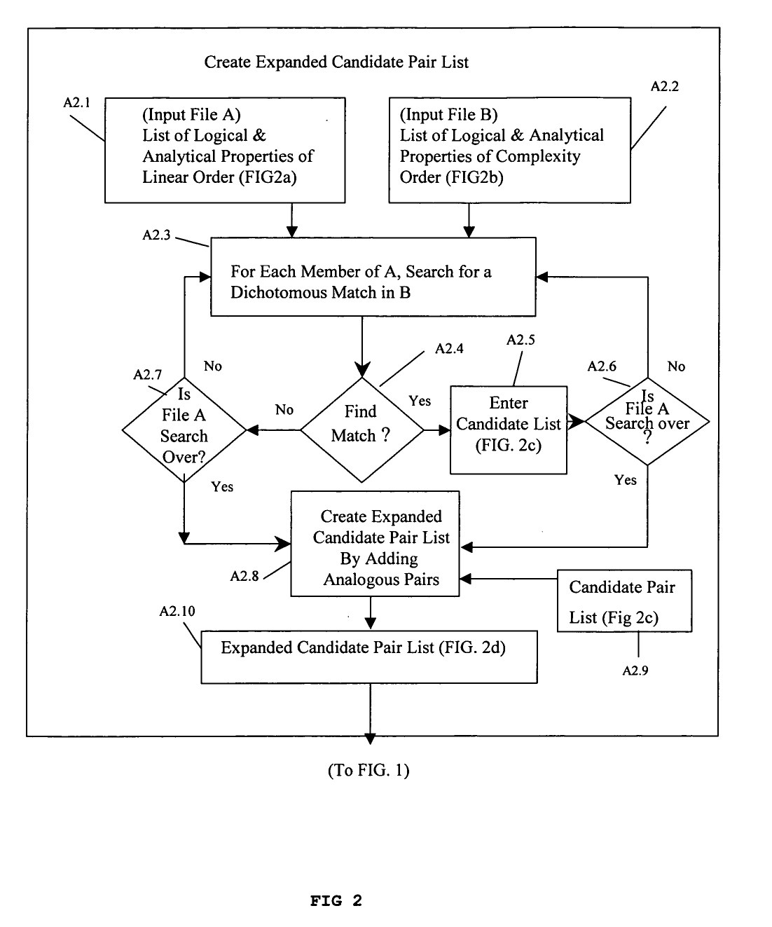

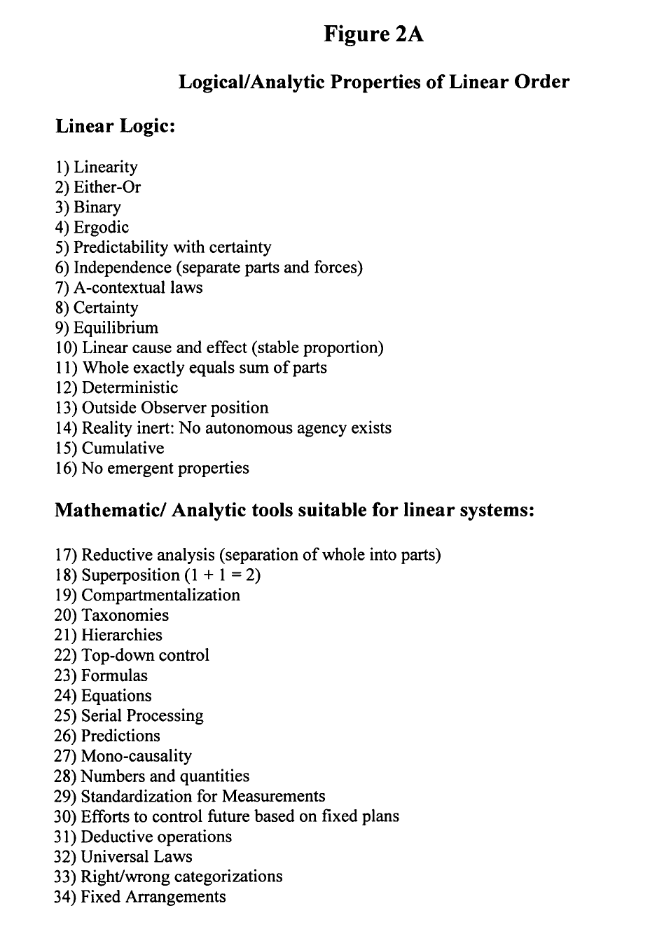

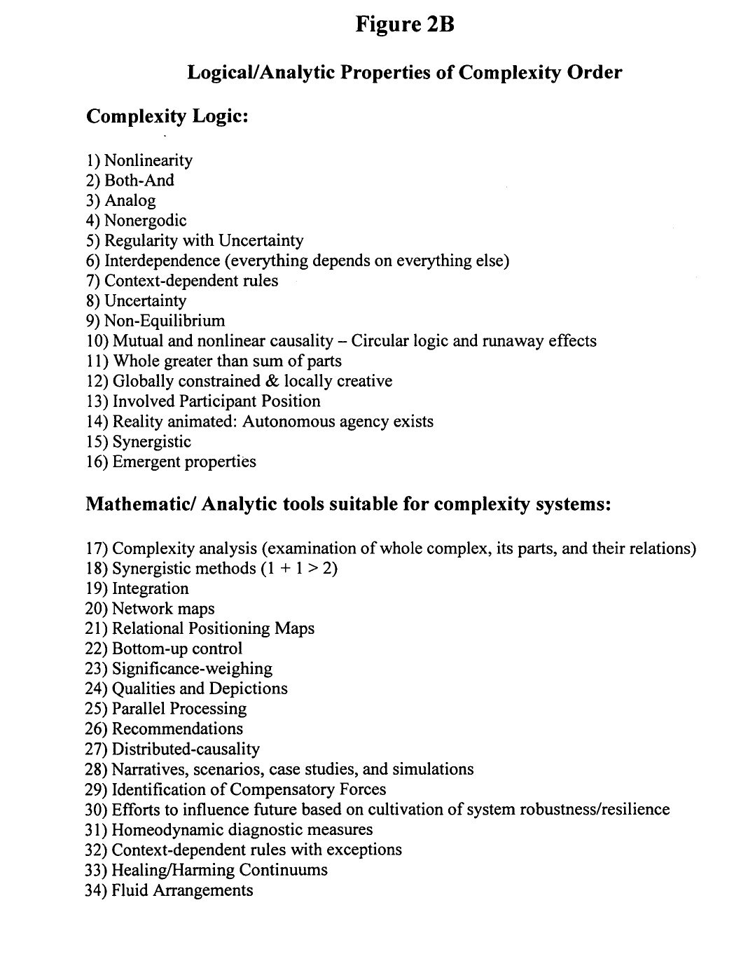

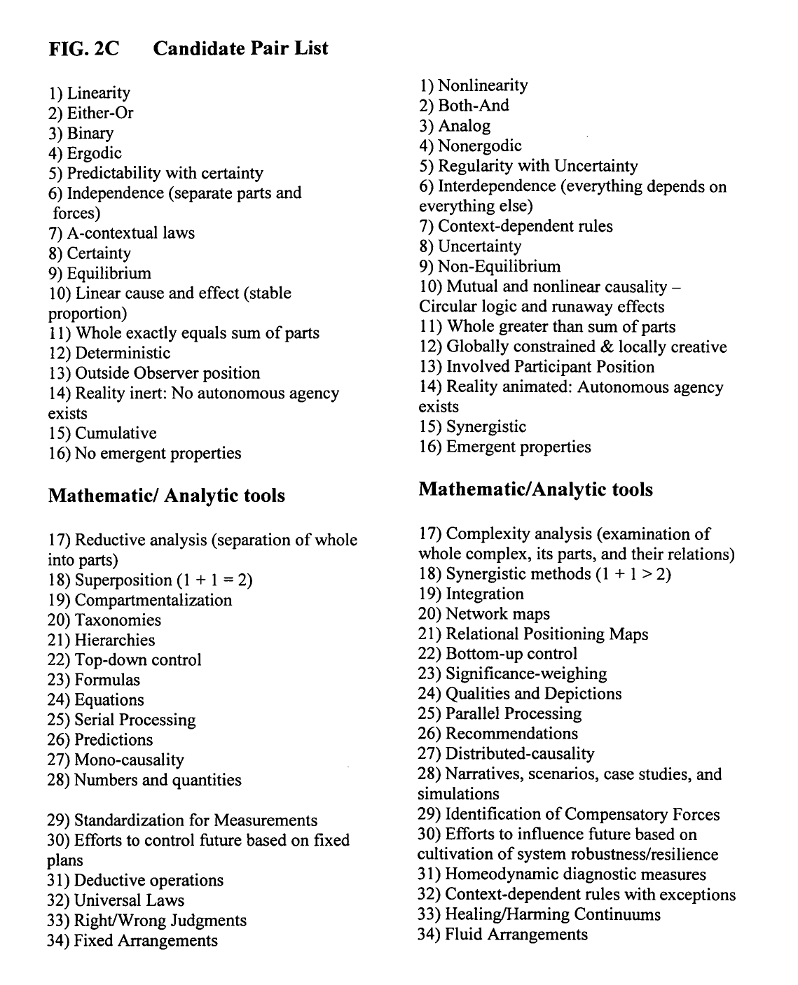

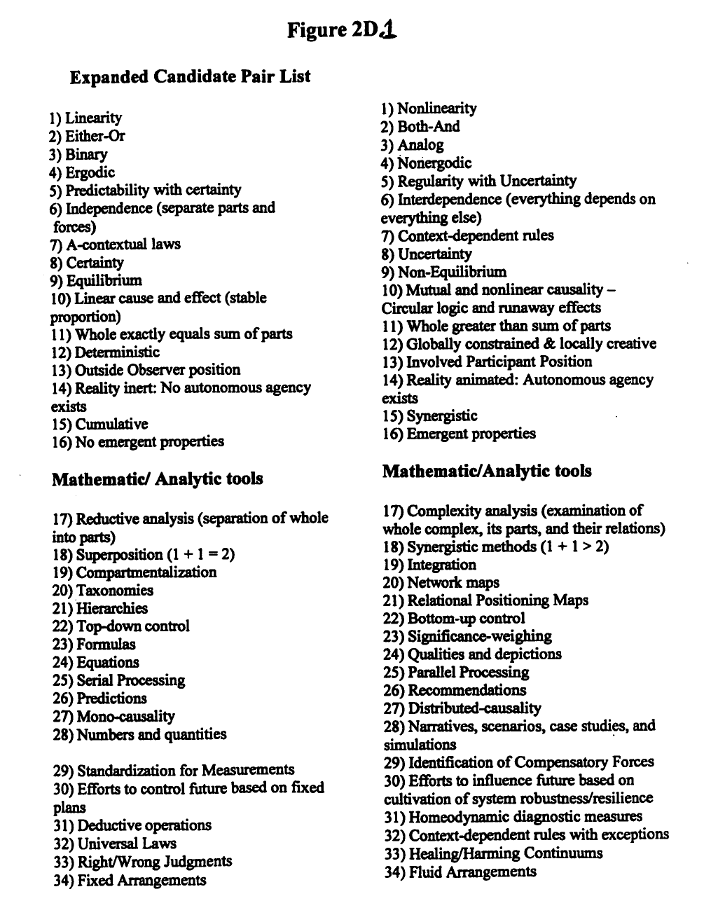

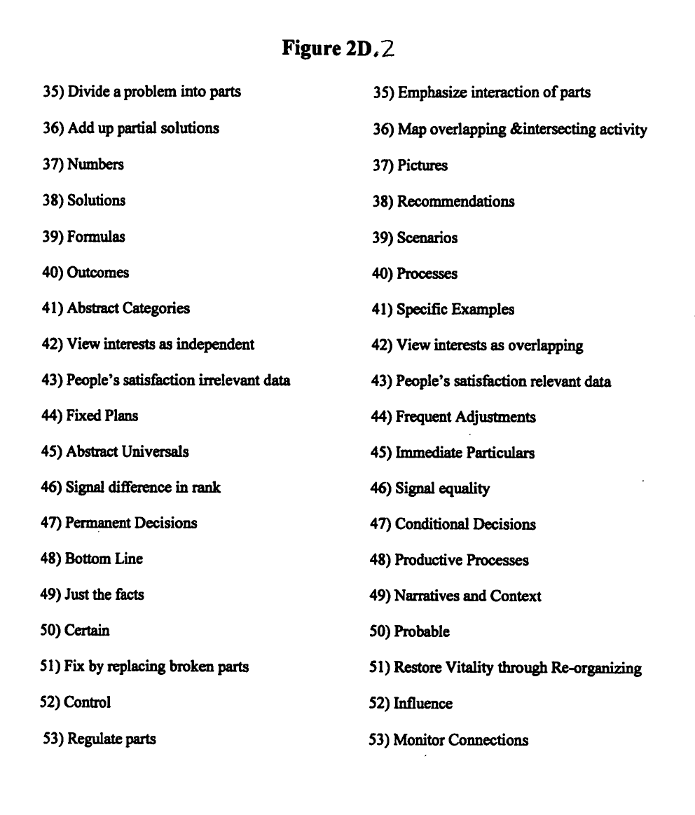

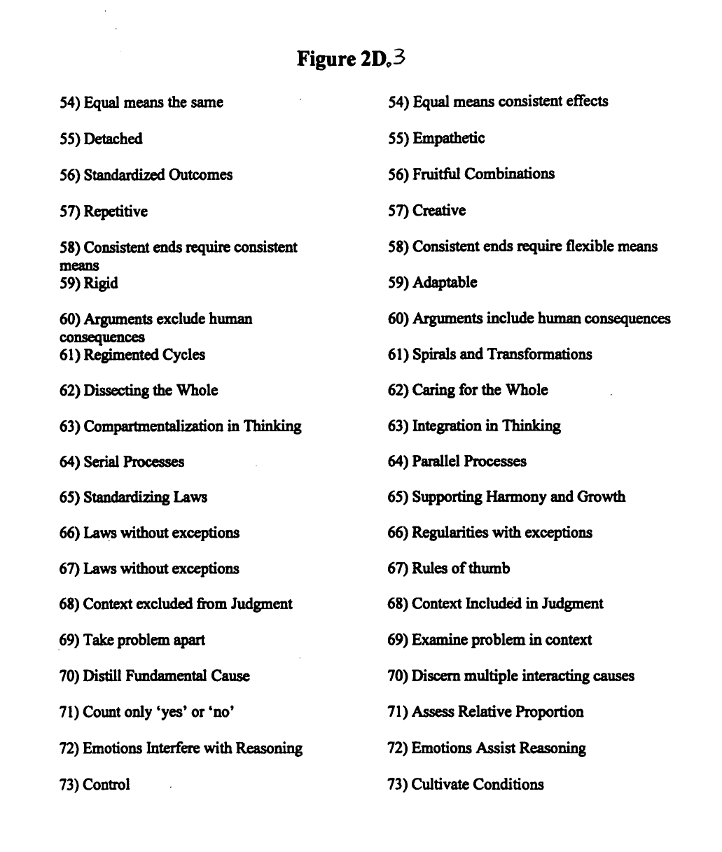

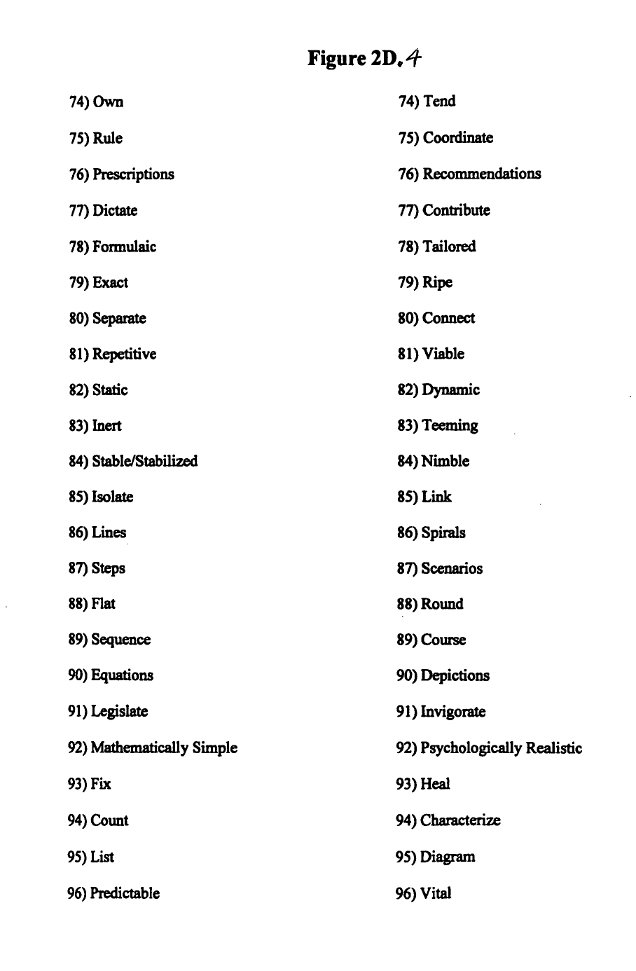

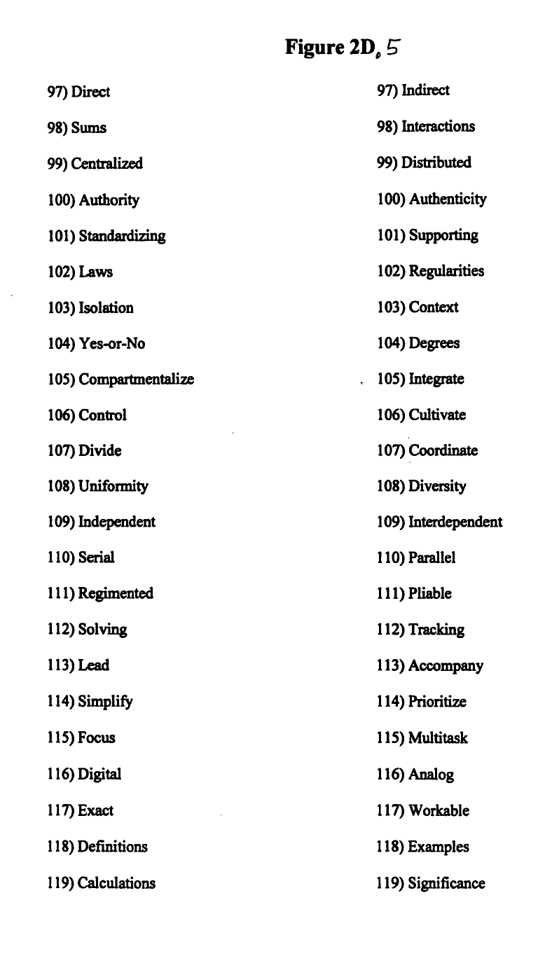

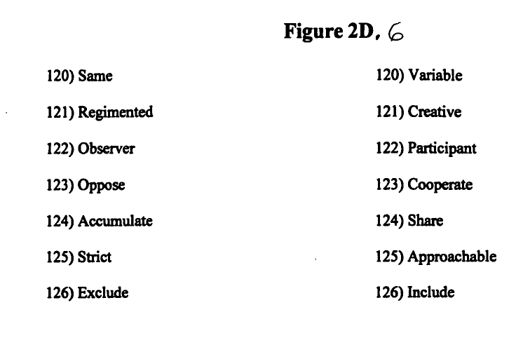

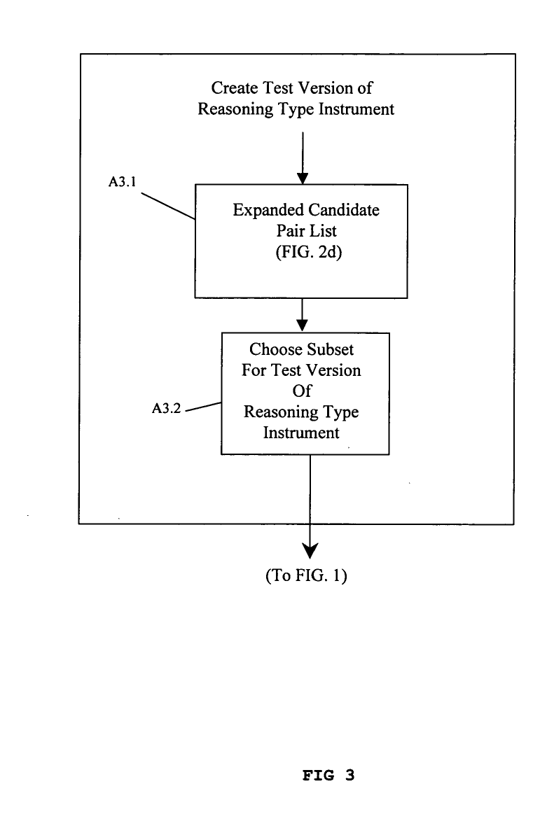

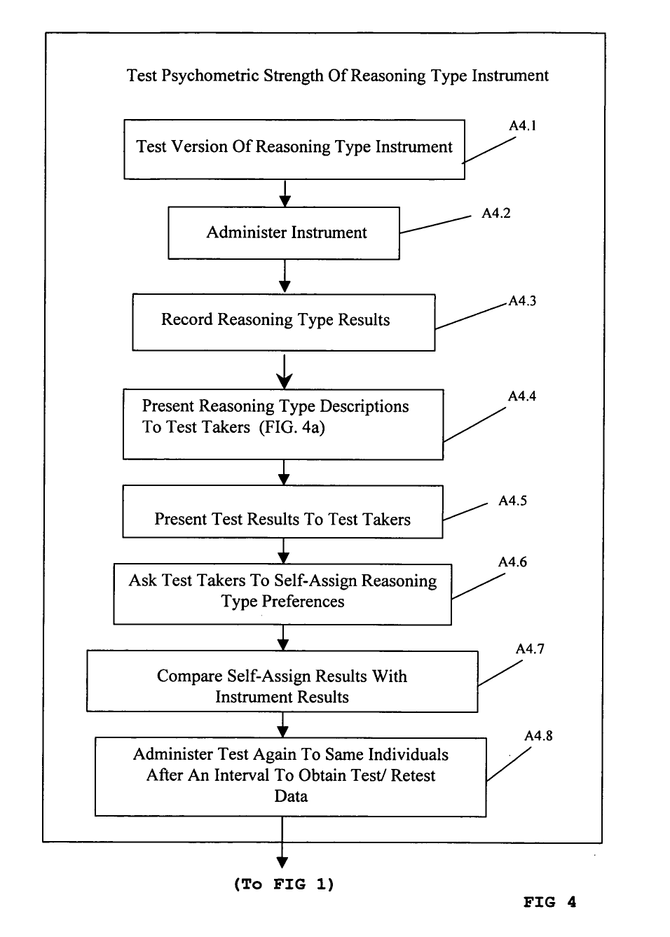

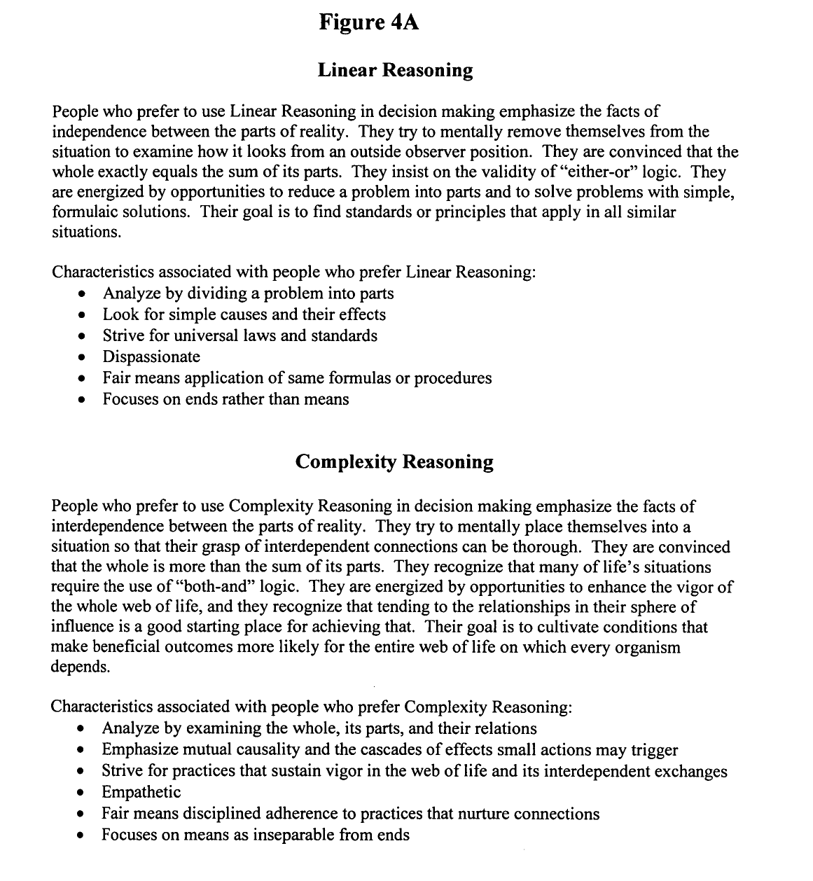

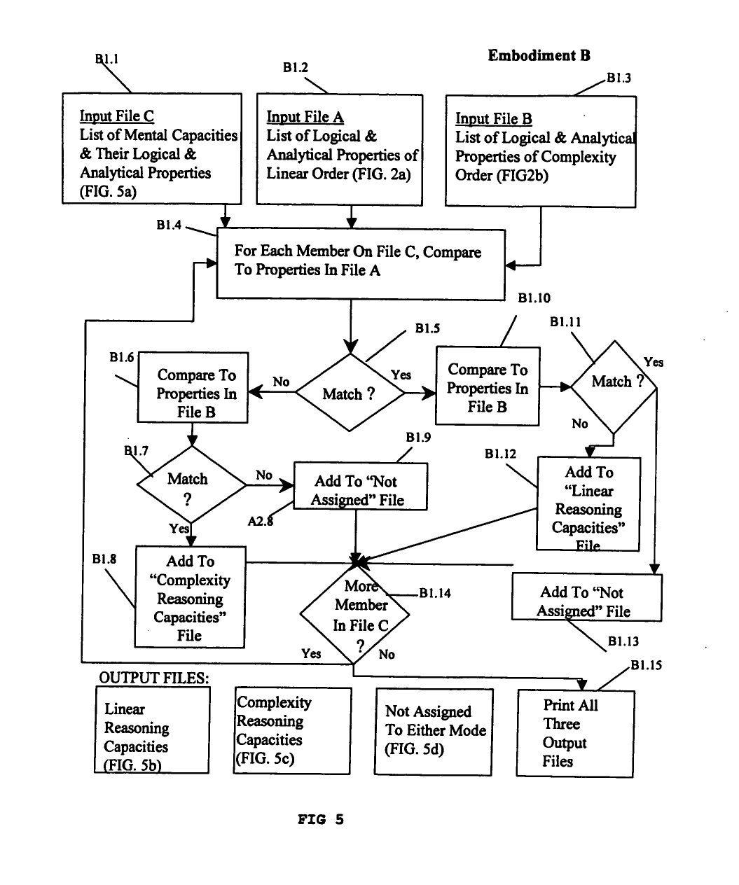

Referring now generally to the Figures and particularly to FIG. 1, FIG. 1 is a flow chart of a first preferred embodiment of the Method of the Present Invention, or first version, or “Embodiment A”. In step A1.1 an expanded list of candidate pairs of terms is generated. A technique for generating the expanded list of pairs of terms is described below in an explanation of FIGS. 2, 2A, 2B, 2C, and 2D. Each pair of terms, hereafter “pair”, comprises a first term and a second term. The first term is descriptive of the linear reasoning mode and the second term is descriptive of the complexity reasoning mode. It is understood that the descriptive terminology of “first” and “second” is defined in this disclosure to distinguish terms within a pair, and is not indicative of the temporal or physical order, placement or position of a term within a presentation of a pair of terms to the investigator. It is further understood that a term may be or comprise one or more human language words expressed in visual alphabetic representations or ideograms, e.g. words expressed in the Roman alphabet, Cyrillic alphabet, Arabic alphabet, or Chinese characters. In certain alternate preferred embodiments of the first version, terms may be expressed as vocalizations of one or more human language words, sounds, Braille and/or other suitable sensory images known in the art.

In step A1.2, and as described below in the discussion of FIG. 3, a test instrument comprising a plurality of pairs are organized for presentation to the investigator. This presentation may occur visually by means of a printed medium, e.g., text printed on a paper sheet, or various electronic media, e.g., a video screen, a light emitting diode configuration, and a cathode ray tube.

In step A1.3, and as described below in the discussion of FIG. 4, the psychometric strength and validity of the test instrument generated in step A1.2 is evaluated in relationship to a suitable standard known in the art. In step A1.4 the results of the evaluation of step A1.3 are examined to determine the next appropriate process step of the first version. Where the instrument meets or exceeds one or more standards of step A1.3, the instrument is published in step A1.5 for use by investigators, and for application by test proctors, counselors and therapists.

Where the test instrument generated in step A1.2 fails to meet the suitable standard known in the art of step A1.3, the first version teaches that step A1.2 is repeated and a new test is generated, the new test comprising a second plurality of pairs selected from the list of pairs of step A1.1.

Referring now generally to the Figures and particularly to FIGS. 2, 2A, 2B, 2C and 2D, FIG. 2 is a detailed flow chart of a method of creating an expanded candidate pair list of terms that may optionally be included in step A1.1 of the first version of FIG. 1. In step A2.1, a first list of a pluralities of terms descriptive of a logical or an analytic property of linear order, hereafter “linear term”, is provided. In step A2.2, a second list of a plurality of terms descriptive of a logical or an analytic property of complexity order, hereafter “complexity term” is provided. In step A2.3 the meaning of the selected linear term of the first list is provisionally matched with a complexity term of the second list, to determine the occurrences of a complexity term forming a dichotomous pair with each sequentially selected linear term. It is understood that each linear term and each complexity term may be used in more than one pair, where no two pairs have the same combination of linear term and complexity term. In step A2.4 the provisional pair generated in step A2.3 is examined to determine if the provisional pair forms a dichotomous pair. Where the provisional pair generated in step A2.3 is found in step A2.4 to form a dichotomous pair, the provisional pair is entered in step A2.5 into a candidate pair list of FIG. 2C. In step A2.6 a determination is made if each linear term of the first list has been used in provisional pair with each complexity term of the second list. If the complete generation of all possible provisional pairs is not complete, than the process of the first version returns to step A2.3, wherein generation of provisional pairs is continued. If the most recently generated provisional pair generated in step A2.3 is not found in step A2.4 to have formed a dichotomous pair, the process of the first version proceeds from step A2.4 to step A2.7. In step A2.7 a determination is made if each linear term of the first list has been used in provisional pair with each complexity term of the second list. If the complete generation of all possible provisional pairs is not complete, then the process of the first version returns to step A2.3, wherein the generation of provisional pairs is continued. Where it is determined in either step A2.6 or step A2.7 that all possible provisional pairs have been generated and examined in step A2.4, the process of the first version proceeds from either step A2.6 or A2.7 onto step A2.8, wherein the candidate list of dichotomous pairs generated in the iterations of step A2.5, of FIG. 2C and herein represented as step A2.9, is expanded to form an expanded list of candidate pairs by selection of terms analogous to one or more of the terms of the candidate list. More specifically, in step A2.8 the first version may generate new candidate pairs by replacing one term or both terms of a pair with an analogous term. A new candidate pair may thus be composed with (a) a term analogous to the linear term of a selected pair and the original complexity term of the instant pair, (b) a term analogous to the complexity term of the instant pair and the original linear term of the instant pair, and (c) a term analogous to the linear term of the instant pair and a term analogous to the complexity term of the instant pair. In step A2.8 the comparison of possibly analogous terms is affected, determinations of one or more findings of an analogous term are made, the new candidate pairs having one or two terms analogous to terms recorded within a candidate pair list generated in step A2.5, and one or more new candidate pairs are added to the candidate pair list to form the expanded candidate pair list. Duplicates of pairs are also removed from the expanded candidate list in step A2.8. In step A2.10 the expanded candidate list, see FIG. 2D, is provided for use in the execution of the first version in step A1.1 of FIG. 1.

Referring now generally to the Figures and particularly to FIG. 2A, FIG. 2A is a representation of an input file A of terms associated with or descriptive of at least one logical or analytic property of linear order that may be input into the optional expanded candidate pair creation of the first version of FIGS. 1 and 2. Each of the terms of input file A is descriptive, indicative, or evocative of the linear reasoning mode. The input file A is provided for application within the first version in step A1.1 as noted in FIG. 1.

Referring now generally to the Figures and particularly to FIG. 2B, FIG. 2B is a representation of an input file B of terms associated with or descriptive of at least one logical or analytic property of complexity order that may be input into the optional expanded candidate pair creation of the first version of FIGS. 1 and 2. Each of the terms of input file B is descriptive, indicative, or evocative of the complexity reasoning mode. The input file B is provided for application within the first version in step A1.1 as noted in FIG. 1.

Referring now generally to the Figures and particularly to FIG. 2C, FIG. 2C is a representation of a list of candidate pairs of terms generated by the iterations of step A2.5 of the FIG. 2, and by inputting the input file A of FIG. 2A (in step A2.1 of FIG. 2) and the input file B of FIG. 2B (in step A2.2 of FIG. 2).

Referring now generally to the Figures and particularly to FIG. 2D, i.e., the combination of FIGS. 2D.1, 2D.2, 2D.3, 2D.4, 2D.5, and 2D.6, FIG. 2D is a representation of an expanded list of candidate pairs of terms generated in step A2.8 by the optional expanded candidate pair creation process of the first version, as illustrated in FIG. 2, wherein the expanded candidate pair list includes the candidate pair list of step A2.5 and the new candidate pairs formed in step A2.8 (of FIG. 2). It is understood that duplicate of new candidate pairs generated are removed from, or not added to, the expanded candidate list in step A2.8.

Referring now generally to the Figures and particularly to FIG. 3, FIG. 3 is a flow chart of the creation of a test instrument in accordance with step A1.2 of the first version of FIG. 1 and the steps and content of FIGS. 2, 2A, 2B, 2C and 2D. In step A3.1, the expanded candidate pair list of step A2.10 of FIG. 2 is provided. In step A3.2 a subset of the plurality of the candidate pairs, hereafter “subset”, are selected from the expanded candidate pair list of FIGS. 1, 2 and 2D. The candidate test is formed in step A3.2 by integrating the informational content of the subset with a test template. The candidate test enables or partially enables the investigator to perceive the candidate pairs of the subset as pairs of terms from which one term may be selected from each pair by the investigator. The selected term would be chosen by the investigator on the criteria of being the term of each pair that is more descriptive of the investigator's cognitive behavior in comparison with the unselected term of each pair. In other words, in an administration of the candidate test in accordance with the first version, the investigator selects one term from each pair on the criteria of being the more descriptive term (of the investigator's cognitive behavior) of the instant pair. The candidate test, with the most recently generated subset, is then evaluated for strength and validity as a psychometric instrument, or personality characteristic determination instrument, in step A1.3 of the first version (as per FIG. 1).

Referring now generally to the Figures and particularly to FIG. 4 and FIG. 4A, FIG. 4 is a process chart of an administration and evaluation of a candidate test, or candidate instrument, developed in accordance with step A1.2 of the first version (as per FIG. 1). As steps A4.1 through A4.6 comprise a preferred embodiment of the evaluation of the psychometric strength of the candidate instrument of step A1.2, the first step A4.1 includes the provision of the candidate instrument, or test version of a reasoning type indication instrument. The candidate instrument is administered to one or more investigators in step A4.2. Each set of selected terms of each investigator who substantially completed the selections of terms from the candidate instrument are analyzed and recorded, in step A4.3, for an indication of dominance or preference of either the linear reasoning mode or complexity reasoning mode. The indication of dominance by one of the two reasoning modes is determined by evaluating the cumulative degree of relatedness of the terms of the selected set to the reasoning modes. It is understood that the cumulative degree may, in various alternate preferred embodiments of the Method of the Present Invention, be calculated on one or more suitable criteria known. For example, in a first variation of the first version a reasoning mode dominance or preference is identified as the mode with the higher raw count of selected terms descriptive, indicative or evocative of the instant mode. In a second variation of the first version the dominant reasoning mode is indicated by the higher weighted score, wherein certain terms and/or selections from the plurality of terms are given a higher score value than another pair or term in the calculation of a weighted score. In step A4.4, and as further discussed below in reference to FIG. 4A, reasoning mode descriptions are presented to each investigator, wherein the descriptions detail certain cognitive behaviors and/or personality aspects that are associated with both reasoning modes, i.e., linear mode and complexity mode. In step A4.5 the scores and/or results derived from the scores of the candidate instruments are each provided to the investigator from whose sets of selections the scores were calculated or otherwise derived. In step A4.6 each investigator is asked to self-assign the dominant reasoning mode of their cognitive behavior. In step A4.7 the self-assignments of dominant reasoning modes provided in the previous step A4.6 are each compared with the dominant reasoning mode selection indicated for the investigator in step A4.3. These comparisons are recorded for use in psychometric evaluation of the test version of the instrument. The candidate instrument may then, after an interval, be administered again to the investigators who substantially completed the instrument administration of step A4.2, in order to obtain retest data in addition to the comparison data previously recorded in step A4.7.

FIG. 4A provides representations of descriptions of the two distinct reasoning modes of linear reasoning and complexity reasoning that is communicated to the investigator in step A4.4.

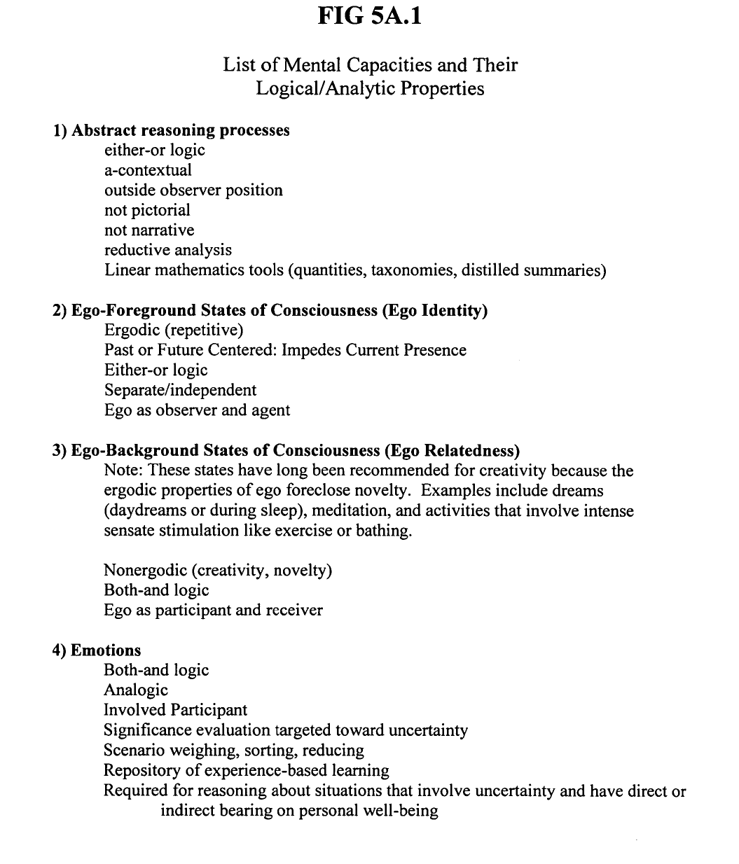

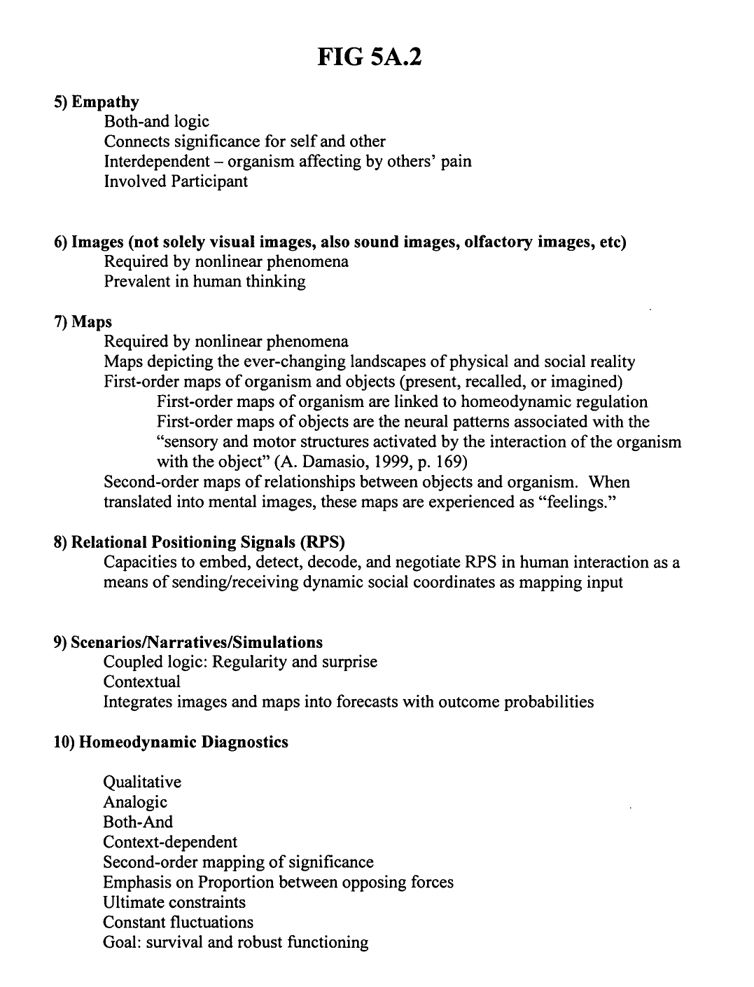

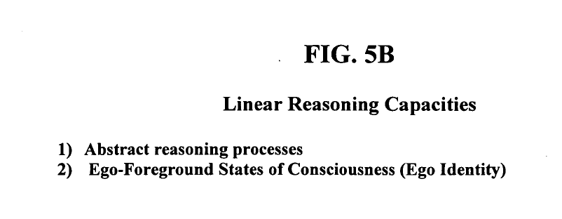

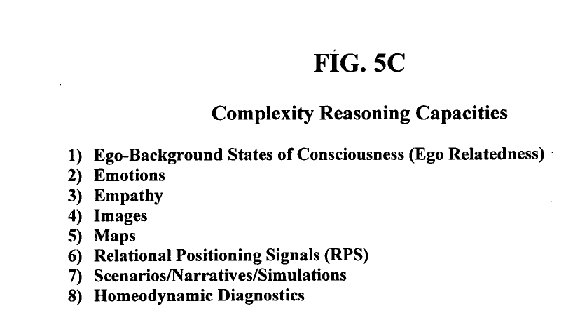

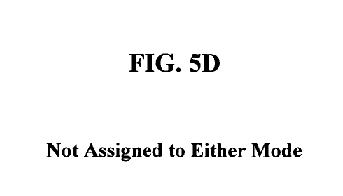

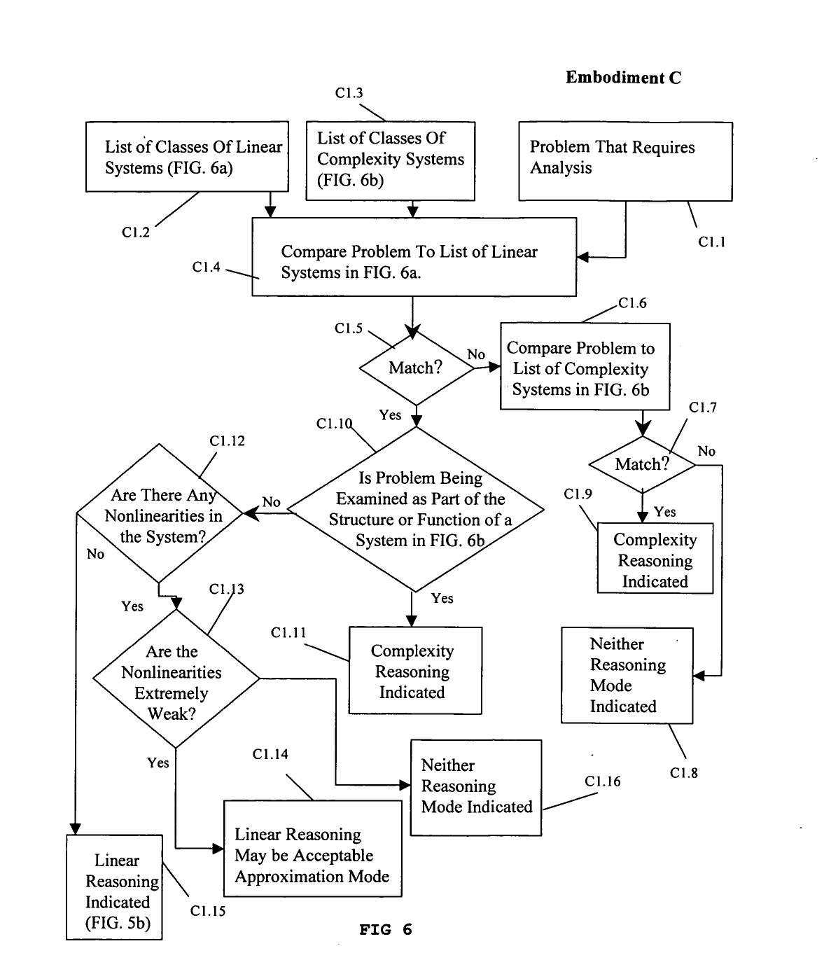

Referring now generally to the Figures and particularly to FIG. 5, FIG. 5 is a flow chart of a second preferred embodiment of the Method of the Present Invention, or second version, or “Embodiment B, wherein mental capacities are associated with linear reasoning and/or complexity reasoning. As shown in FIG. 5, input file A and input file B are provided as well as a list of mental capacities, hereafter “input file C”, where each mental capacity included in input file C is associated with one or more descriptor. Each descriptor indicates a logical and/or an analytic property of the associated mental capacity. Version two generates three output files, namely a linear output file, a complexity output file, and an unassigned output file. The linear output file contains a list of mental capacities, wherein each included mental capacity has (a) at least one descriptor matching a linear term, and (b) no descriptors matching a complexity term. The complexity output file contains a list of mental capacities, wherein each included mental capacity has (a) at least one descriptor matching a complexity term, and (b) no descriptors matching a linear term. The unassigned output file contains a list of mental capacities, wherein each included mental capacity (a) has no descriptor that is found to be descriptive, indicative or evocative of either the linear or the complexity reasoning modes, or (b) has at least one descriptor that describes, indicates or evokes the linear reasoning mode, and at least one descriptor that describes, indicates and evokes the complexity reasoning mode.

In step B1.4, descriptors of each mental capacity of input file C are compared for matching with the linear terms of input file A. In step B1.6 the mental capacities that do not have a single descriptor matching with the linear terms of input file A are then compared in step B1.6 for matching with the complexity terms of input file B. A mental capacity is added to the complexity output file in step B1.8 if (a) found in step B1.4 to have no descriptor matching any linear term of input file A, and (b) found in step B1.6 to have at least one descriptor matching any complexity term of input file B.

In step B1.10, each mental capacity of input file C that has at least one descriptor matching a linear term of input file A are compared for matching with the complexity terms of input file B. A mental capacity is added to the linear output file in step B1.12 if (a) found in step B1.10 to not have a single descriptor matching any complexity term of input file B, and (b) found in step B1.4 have at least one descriptor matching a linear term of input file A.

Mental capacities having no descriptors that match any term from either input file A or input file B are added to the unassigned output file in step B1.9. Mental capacities are assigned in step B1.13 to the unassigned output file when found (in step B1.4) to have at least one descriptor to matching a linear term of input file A, and (in step B1.10) to also have at least one descriptor matching a complexity term of input file B. All three output files generated in the process described in FIG. 5 are printed or otherwise communicated to a storage medium, a software agent, a researcher, or other human or system in step B1.15 for use in assigning or associating reasoning modes with mental capacities.

Referring now generally to the Figures and particularly to FIGS. 5A, 5B, 5C and 5D, FIG. 5A, i.e., the combination of FIGS. 5A.1 and 5A.2, is a representation of a list of mental capacities and descriptors that may comprise an input file C of the second version of FIG. 5, whereby a list of descriptors of mental capacities of 5A may be examined in relationship to the input file A of FIG. 2A and the input file B of FIG. 2B in accordance with the second version of FIG. 5. FIG. 5B is an output listing of linear reasoning capacities identified in the process of FIG. 5. FIG. 5C is an output listing of complexity reasoning capacities identified in the process of FIG. 5. FIG. 5D is a blank output listing to be used in listing reasoning capacities not assigned to either linear reasoning mode nor complexity reasoning mode in the process of FIG. 5.

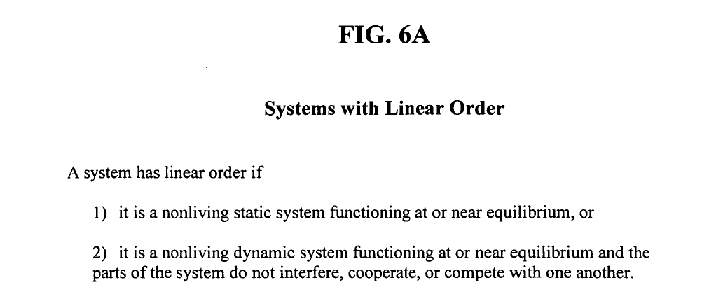

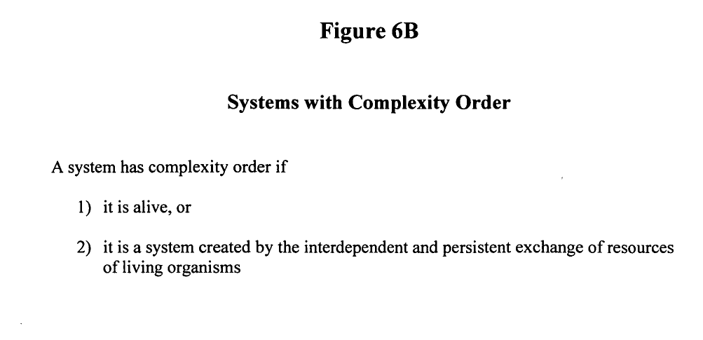

Referring now generally to the Figures and particularly to FIG. 6, FIG. 6 is a flow chart of a third preferred embodiment of the Method of the Present Invention, or third version, or “Embodiment C”, wherein a problem description, hereafter “problem description”, in step C1.1, may be examined to determine the more appropriate reasoning mode for use in meeting the analytic requirements of the problem description. A list of classes of linear systems is provided in step C1.2 and a list of classes of complexity systems is provided in step C1.3. FIG. 6A provides a listing of systems having linear order, where the listing is input in step C1.2 of the process of FIG. 6. FIG. 6B provides a listing of systems having complexity order, where the listing is input in step C1.3 in the process of FIG. 6. The problem description is compared in step C1.4 to the list of linear classes. If no match is found between any of the linear classes and the problem description, the process of the third version passes through step C1.5 to step C1.6, wherein the problem description is compared in step C1.6 to the list of complexity classes. If no match is found between any of the complexity classes and the problem description then the process of the third version passes through step C1.7 to step C1.8 wherein the outcome of the instant application of third version is to indicate that no preference in reasoning modes has been determined. If, however, a match is found between any of the complexity classes and the problem description then the process of the third version passes through step C1.7 to step C1.9, wherein the outcome of the third version is to indicate that the problem description is better addressed by the complexity reasoning mode than by the linear reasoning mode. Returning our attention back to step C1.4, if a match is found between any of the linear classes and the problem description then the process of the third version passes from step C1.4 through step C1.5 and to step C1.10. In step C1.10 the problem description is examined to determine whether the problem description is a part or element of a complexity system. If the problem description is determined in step C1.10 to describe a part or element of a complexity system, the process of the third version passes from step C1.10 to step C1.11, wherein the outcome of the third version is to indicate that the problem description is better addressed by the complexity reasoning mode than by the linear reasoning mode. If, however, step C1.10 determines that the problem description is not a part or element of a complexity system, the process of the third version passes from step C1.10 to step C1.12, wherein the problem description is examined to learn if any substantive non-linearities are found in the problem description. If no substantial non-linearities are found in the problem description, the process of the third version proceeds to step C1.15, wherein the outcome of the instant application of third version is to indicate that the problem description is better addressed by the linear reasoning mode than by the complexity reasoning mode. If, however step C1.12 determines that substantive non-linearities are found in the problem description, the process proceeds on from step C1.12 to step C1.13, wherein the problem description is examined to learn if the substantive non-linearities of the problem description are extremely weak. If all of the substantive non-linearities identified in the problem description are determined to be weak in step C1.13, then the process of the third version passes from step C1.13 to step C1.14, wherein the outcome of the third version is to indicate that the linear reasoning mode may be an acceptable approximation mode. If, however, even one of the substantive non-linearities identified in the problem description are determined to be more than weak in affect, then the process of the third version passes from step C1.13 to step C1.16, wherein the outcome of the instant application of third version is to indicate that no preference in reasoning modes has been determined.

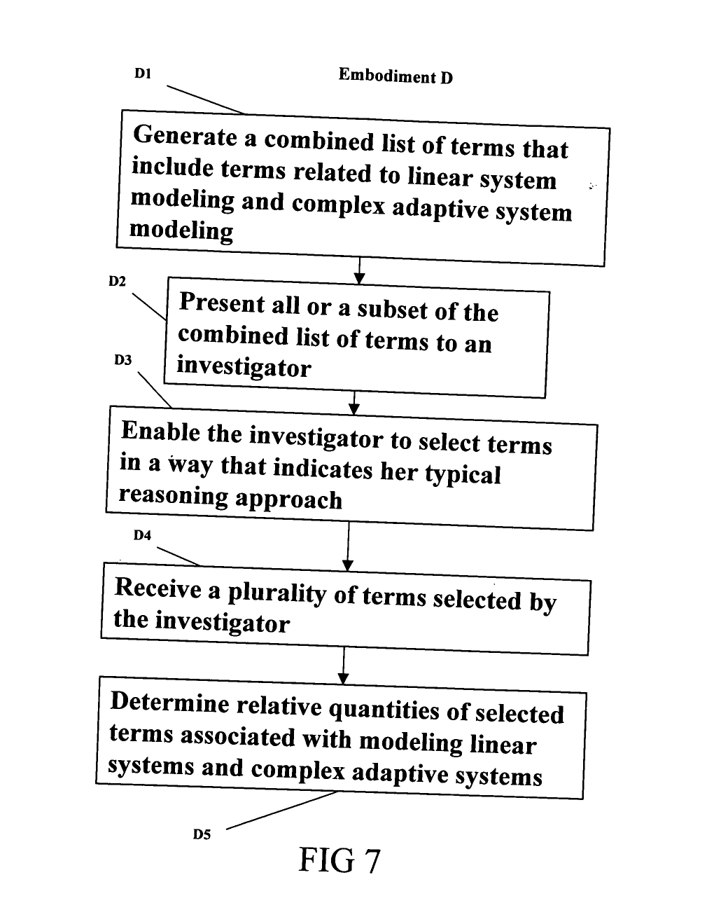

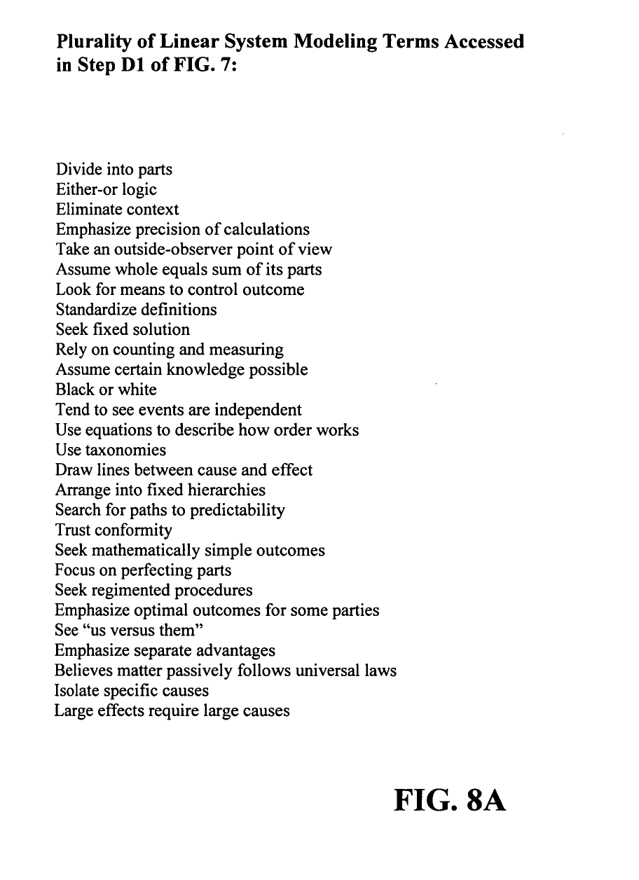

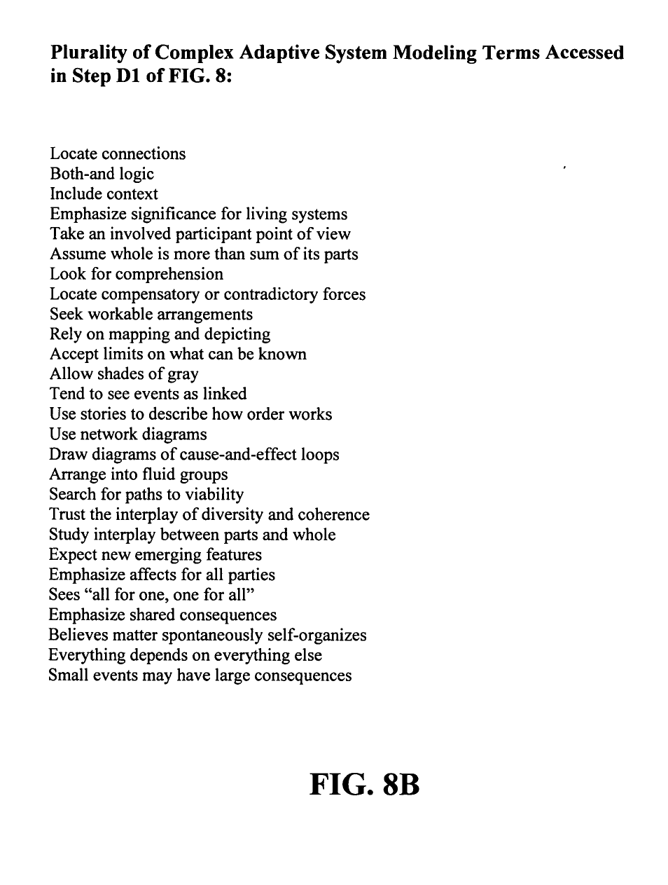

Referring now generally to the Figures and particularly FIGS. 7, 8A & 8B, FIG. 7 is flow chart of a fourth preferred embodiment of the Method of the Present Invention, or “Embodiment D”. In step D1 a combined plurality of terms is generated that is a combined list of terms selected from (a) a plurality of linear modeling terms of FIG. 8A and (b) a plurality of complex adaptive system modeling terms of FIG. 8B. In step D2 the investigator is provided with all or a subset of the combined plurality of terms. The investigator is enabled in step D3 to select terms from the combined plurality of terms and indicate the selected terms to a test proctor. The investigator selects terms from the combined plurality of terms that represent the assumptions that the investigator typically makes and/or the methods the investigator typically uses when trying to figure out a system, and reports the selected terms to a test proctor. In step D4 the test proctor receives the selected terms from the investigator. The test proctor determines in step D5 the relative quantities of selected terms from (i) the plurality of complex adaptive system modeling terms, and (ii.) the plurality of linear system modeling terms. The proctor may then optionally inform the investigator if the investigator has selected more terms from either the plurality of complex adaptive system modeling terms or the plurality of linear system modeling terms. The proctor may further optionally present the investigator with the description of the complexity reasoning mode and the description of the linear reasoning mode.

Referring now generally to the Figures and particularly FIG. 9, FIG. 9 illustrates a first alternate preferred embodiment of the Present Invention 2, or electronics communications network 2, hereafter “first system 2”, wherein software encoded instructions 4 enable the investigator to interact with a computational device 6, hereafter “first computer” 6, and to generate responses and selections of the investigator that are indicative of, or related to, the investigator's reasoning mode preferences, in accordance with certain automated alternate preferred embodiments of the Method of the Present Invention, and optionally as disclosed in the Figures. It is understood that the software encoded instructions 4 may optionally comprise information used in the execution of one or more preferred embodiments of the Method of the Present Invention, and as described in this disclosure, wherein the information may include terms, system descriptions, and/or test instrument formats. The first computer 6 is communicatively coupled with the communications network 2 and may be a personal computer or other suitable electronic computational device known in the art configured to present information or representations of information to the investigator, and to receive responses, commands, data, and/or informational input from the investigator. The first computer 6 includes a central processing unit 6A and a system memory 6B communicatively coupled via a communications bus 6C. All or at least some of the software encoded instructions 4 may be stored in the system memory 6B for access by the central processing unit (hereafter “CPU 6A”) Optionally, the first computer 6 includes a communications link 8 to a media reader 10, wherein the first computer 6 is configured to read the software encoded instructions 4 from an electronic memory storage media 12, hereafter media 12, and to at least partially provide software encoded instructions 4 to the CPU 6A via the communications bus 6C (hereafter “comms bus 6C”). The media reader 10 and the media reader 12 may optionally be configured to enable the media reader 10 to write software coded information and/or instructions onto the media 12. Alternatively or additionally, the first computer 6 may be communicatively coupled with an electronic network 14 of the communications network 2 and receive at least some of the software coded instructions 4 from a second computer 16 or a digital memory system 18 via the electronic network 14. The electronic network 14 and the communications network 2 may be or comprise the Internet, an extra-net, an intra-net, a telephony system or other suitable electronic communications system known in the art. The investigator may operate the first computer 6 to execute the software-coded instructions 4 in a testing session. The testing session includes the instantiation via the first computer 6 of one or more of the embodiments or steps of the Method of the Present Invention as presented in this disclosure, or derivations made obvious to one of ordinary skill in the art in light of this disclosure. An output device 20 of the first computer 6 is communicatively linked to the CPU 6A and is or comprises a presentation module 22. The presentation module 22 is configured to present terms to the investigator for selection. The presentation module 22 may be configured to present the terms to the investigator as (1) a printed medium, (2) a visually projected image, (3) an electronic video screen, and/or (4) a sensory output perceptible by the investigator. The presentation module 22 may optionally be configured as or with (1) a printer to receive terms in an electronic format and to communicate the terms to the investigator on a printed media, e.g., typed words on a paper sheet; (2) a visual projector to receive terms in an electronic media at to communicate the terms to the investigator as a visual images projector onto an external surface area, e.g., a white screen, (3) an electronic video screen to receive terms in an electronic media and communicate the terms to the investigator as visual images on the video screen; (4) a sensory output device, e.g., an audio output device, to receive terms in an electronic format and communicate the terms to the investigator in a sensory form, e.g., audible words; and/or another suitable output device known in the art.

An input device 24 of the first computer 6 is configured to enable the investigator to indicate term selections by the investigator to the CPU 6A and/or system memory 6B via the comms bus 6C. The input may be or comprise a keyboard, a mouse and/or one or more other suitable input devices known in the art.

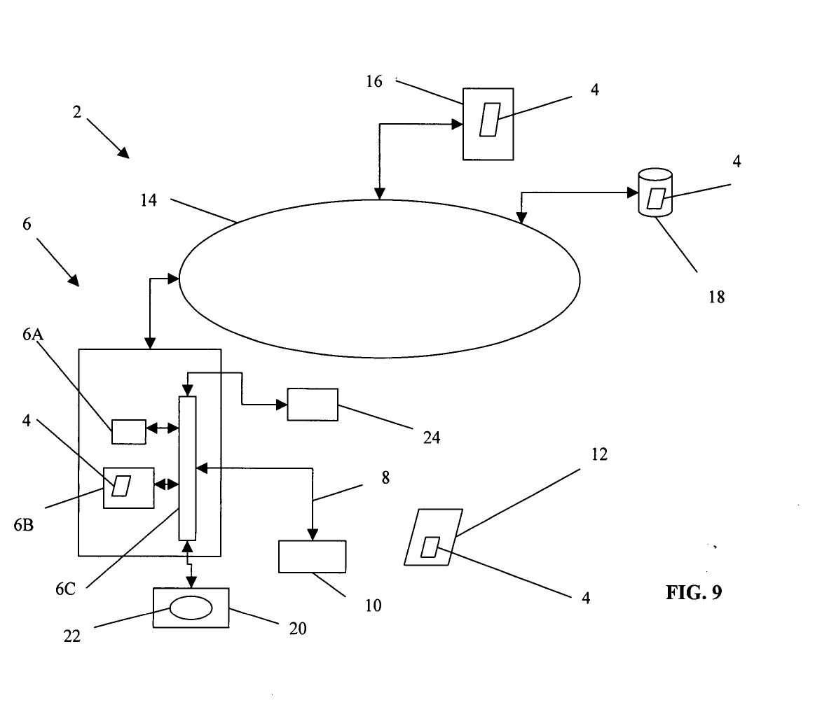

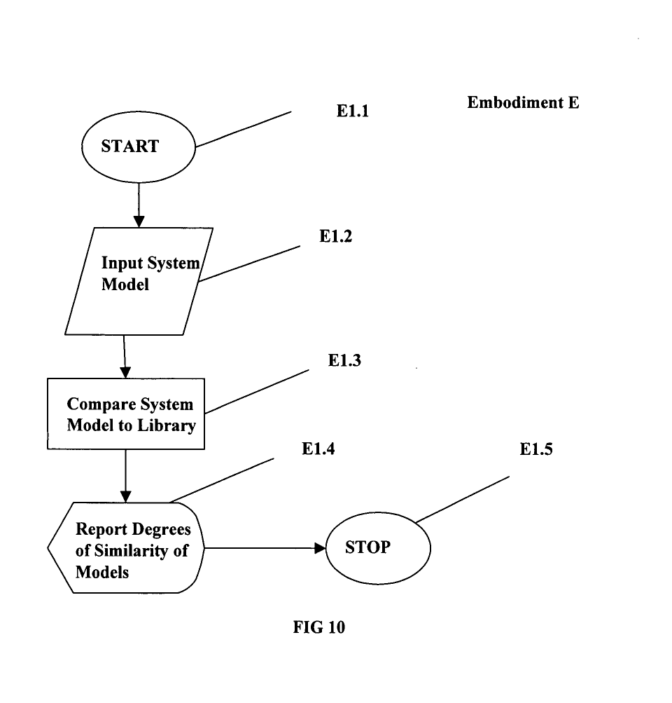

Referring now generally to the Figures and particularly to FIG. 10, FIG. 10 presents a flow chart of a fifth alternate preferred embodiment of the Method of the Present Invention, or “Embodiment E”, that may be instantiated by means of the first system 2 of FIG. 9 and with the software encoded instructions 4 to direct the first system 2 to accept an input of a description of a system model in step E1.2. The system model is a software encoded description of a system under investigation, wherein the software encoded description of the system model accepted by the first system 2 is formatted to enable comparison with a library of software encoded system descriptions stored within or available to the first system 2. The software encoded description of the system under investigation may be provided to the first system 2 by means of the media reader 10, the media 12, the computer network 12, and/or the input device 24. In step E1.3 the system model input into the first system 2 in step E1.2 is compared with the library of software encoded system descriptions of the encoded software instructions 4, whereby a degree of similarity of found between the input system description of step E1.2 and one or more of the software encoded systems descriptions of the library of the software encoded instructions 4 is generated. The comparison for degree of similarity of step E1.3 is affected by means of a suitable method of comparison of mathematical descriptions or software encoded models known in the art. In step E1.4 the degree(s) of similarity is reported by the first system 2 by means of the output module 20, the media 12, and/or the computer network 14. The report of the first system 2 of step E1.3 may include (1) an identification of the software encoded description of the system under investigation, (2) identification of a software encoded description of the library of the software encoded instructions 4, (3) a metric describing a degree of similarity of the descriptions of the input description of step E1.2 and the software encoded description of the library, (4) identification of the relevant software encoded description of the library as being a complexity system or a linear system, or relative complexity or linearity, and/or (5) identification of the method of comparison applied by the first system 2 in determining the degree of similarity.

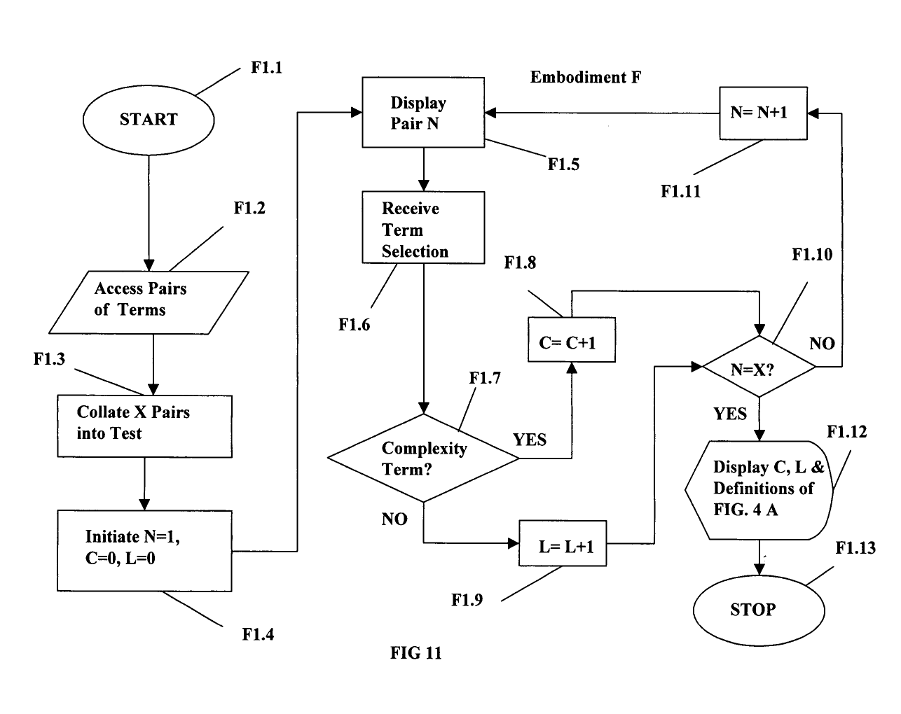

Referring now generally to the Figures and particularly to FIG. 11, FIG. 11 presents a flow chart of a sixth alternate preferred embodiment of the Method of the Present Invention, or “Embodiment F”, that may be instantiated by means of the first system 2 of FIG. 9 and with the software encoded instructions 4. In step F1.2 the first system 2 accesses a plurality of pairs terms from the software encoded instructions 4. In step F1.3 the first system 2 collates all or a subset of the plurality of pairs of terms accessed in step F1.2 and according to a test format of the software encoded instructions 4 and presenting a quantity of X pairs of terms. In step F1.4 the variables of C, L, and N are initialed as C equal to zero, L equal to zero and N equal to one. The C variable represents the quantity of complexity reasoning mode terms selected by the investigator. The L variable represents the quantity of linear reasoning mode terms selected by the investigator. The variable N is used to determine when all of the pairs have been presented to the investigator. Embodiment F will present pairs of terms until N is incremented to equal X. A selected pair is displayed to the investigator in step F1.5 by means of the output module 20. The first system 2 receives a term selection from the investigator via the input device 24 in step F1.6. Step F1.7 queries and determines if the selected term communicated in step F1.6 is a complexity reasoning mode term. If the term indicated in step F1.6 is determined to be a complexity reasoning term in step F1.7, then the C variable is incremented in step F1.8. If the term indicated in step F1.6 is not determined to be a complexity reasoning term in step F1.7, then the L variable is incremented in step F1.9. The sixth version of the Method of the Present Invention progresses from both step F1.8 and step F1.9 to step F1.10, where the value of the variable N is examined to see if N has been incremented to equal X. If the value of N is determined not to be equal to X in step F1.10, then the N variable is incremented in step F1.11, and the execution of the sixth alternate preferred embodiment of the Method of the Present Invention proceeds to step F1.5, wherefrom another pair presentation is affected. If the value of N is found to be equal to X in step F1.10, then the execution of the sixth alternate preferred embodiment of the Method of the Present Invention proceeds to step F1.2, wherein the values of the variables C and L and the reasoning mode definitions of FIG. 4A are presented to the investigator via the output module 20 of the first system 2. It is understood that the output module 20 may be a printer that provides the presentation of the variables C and L, and the definitions of FIG. 4A, to the investigator as a visually observable printed media.

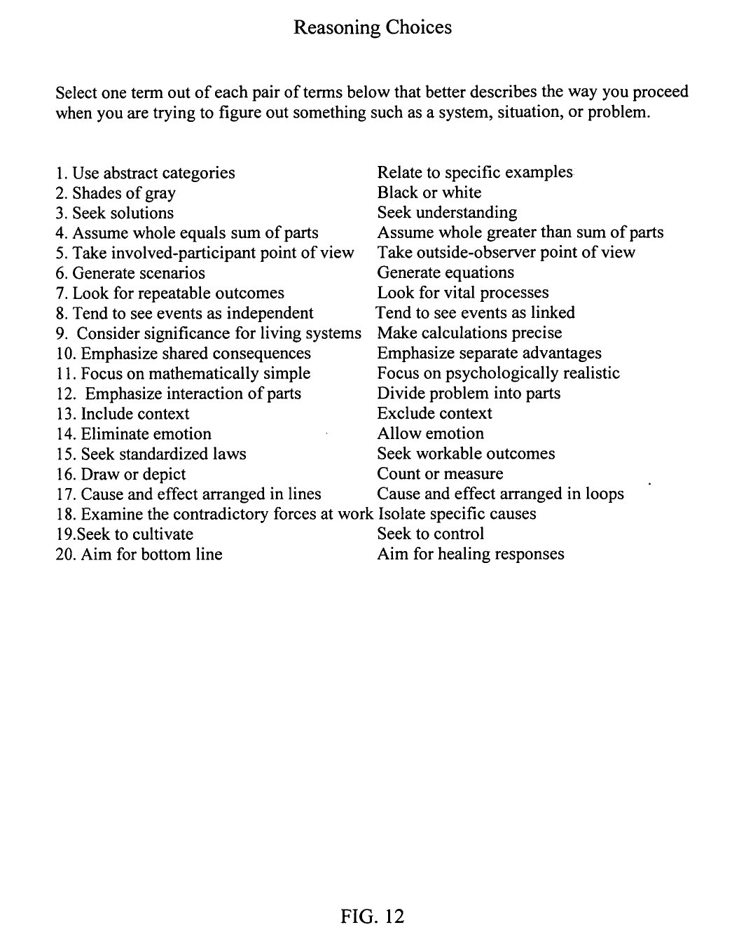

Referring now generally to the Figures and particularly to FIGS. 11 and 12, FIG. 12 is a representation of a display of a test instrument of the sixth alternate preferred embodiment of FIG. 11 comprising pairs of terms, wherein the test instrument is presented to the investigator in a printed media. The value of X in the test instrument of FIG. 12 is 20, and the test is collated and formatted in accordance with the software encoded instructions 4 of the first system 2. The investigator selects one term from each pair of terms by means of a visible marker, such as an ink pen or a leaded pencil.

Although the examples given include many specificities, they are intended as illustrative of only certain possible embodiments of the Present Invention. Therefore, it is to be understood that the Present Invention may be practiced other than as specifically described herein. Other embodiments and modifications will, no doubt, occur to those skilled in the art. The above description is intended to be illustrative, and not restrictive. Thus, the examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Other suitable techniques and methods known in the art can be applied in numerous specific modalities by one skilled in the art and in light of the description of the Present Invention described herein. Many other embodiments will be apparent to those of skill in the art upon reviewing the above description. The scope of the Present Invention as disclosed and claimed should, therefore, be determined with reference to the knowledge of one skilled in the art and in light of the disclosures presented above.

I claim:

1. A method for enabling an investigator to self indicate a reasoning mode behavior, the method comprising (a) selecting a pair of terms having a first term and a second term, the first term associated with linear reasoning and the second term associated with complexity reasoning, (b) presenting the pair of terms to the investigator, and (c) enabling the investigator to choose either the first term or the second term as being more descriptive of the investigator's reasoning mode behavior, whereby the mode of reasoning associated with the selected term indicates the investigator's dominant reasoning mode.

2. The method of claim 1, wherein the pair of terms is presented to the investigator by means of a presentation module selected from the group consisting of a printed medium, a visually projected image, an electronic video screen, and a sensory data output device.

3. The method of claim 1, wherein the method further comprises (d) selecting a plurality of pairs of terms, each pair of terms having a first term associated with linear reasoning and a second term associated with complexity reasoning (e) presenting the plurality of pairs of terms to the investigator, and (f) enabling the investigator to choose either the first term or the second term of each pair of terms as being more descriptive of the investigator's reasoning mode behavior, whereby the relative quantities of selected first terms and selected second terms indicates the investigator's dominant reasoning mode.

4. The method of claim 3, wherein at least one term is weighted in relationship to at least one other term, and the relative weighted and summed scores of the selected first terms and the selected second terms indicates the investigator's dominant reasoning mode.

5. The method of claim 1, wherein descriptions of both reasoning modes are communicated to the investigator as well as the reasoning mode preference associated with the term selected by the investigator in step c, whereby the investigator may consider the significance of the term selection.

6. The method of claim 3, wherein descriptions of both reasoning modes are communicated to the investigator as well as the reasoning mode preference indicated by the quantity of terms associated with each reasoning mode selected by the investigator in step c, whereby the investigator may consider the significance of the term selections.

7. The method of claim 3, wherein the relative quantities of selected first terms and selected second terms is communicated to the investigator, and the mode of reasoning associated with each of the first terms and the second terms are indicated to the investigator, whereby the investigator may consider the significance of the term selections.

8. The method of claim 4, wherein descriptions of both reasoning modes are communicated to the investigator as well as the reasoning mode preference indicated by the weighted average of the terms selected by the investigator in step c, whereby the investigator may consider the significance of the term selections.

9. The method of claim 3, wherein the method further comprises (a) documenting the results of a plurality of instances of multiple investigators choices of terms from the plurality of pair terms, (b) presenting a provisional pair of terms to the investigators, (c) documenting the choices of terms of the provisional pair of terms by the investigators, and (d) measuring the correlations of term choices of the provisional pair of terms by the investigators to the documented results of the plurality of instances of step a.

10. The method of claim 9, wherein the provisional pair of terms is added to the plurality of pairs of terms when the correlated validity of the term choices of the provisional pair of terms by the investigators exceeds a statistical value.

11. The method of claim 1, wherein at least one term selected from the pair of terms is an image selected from the group of images comprising a visual image, a pictograph, a color, a pattern of color, a sound, a dynamic image, and a sensory image.

12. A method for generating a plurality of dichotomous pairs of terms, each pair of terms having a first term and a second term, the first term associated with linear reasoning and the second term associated with complexity reasoning, the method comprising:
a. generating a first list of candidate first terms, the first list of candidate first terms comprising a plurality of candidate first terms, each candidate first term describing a quality or an aspect of linear reasoning;
b. generating a second list of candidate second terms, the second list of candidate second terms comprising a plurality of candidate second terms, each candidate second term describing a quality or an aspect of complexity reasoning;
c. determining if each candidate first term forms a dichotomous pair of terms with each candidate second term; and
d. recording each determination of a dichotomous pair of terms, whereby the candidate first term and the candidate second term of each identified dichotomous pair are associated and documented.

13. The method of claim 12, wherein the method further comprises (e) selecting a dichotomous pair of terms determined in step c and recorded in step d; (f) presenting the pair of terms to the investigator, and (g) enabling the investigator to choose either the candidate first term or the candidate second term of the dichotomous pair as being more descriptive of the investigator's reasoning mode behavior, whereby the mode of reasoning associated with the selected term indicates the investigator's dominant reasoning mode.

14. The method of claim 13, wherein descriptions of both reasoning modes are communicated to the investigator as well as the reasoning mode preference associated with the term selected by the investigator in step g, whereby the investigator may consider the significance of the term selection.

15. The method of claim 12, wherein the method further comprises (e) selecting a plurality of dichotomous pairs of terms, each pair of terms having a candidate first term associated with linear reasoning and a candidate second term associated with complexity reasoning (f) presenting the plurality of dichotomous pairs of terms to the investigator, and (g) enabling the investigator to choose either the candidate first term or the second candidate term of each dichotomous pair of terms as being more descriptive of the investigator's reasoning mode behavior, whereby the relative quantities of selected candidate first terms and selected candidate second terms indicates the investigator's dominant reasoning mode.

16. The method of claim 15, wherein the method further comprises:
(h) recording the terms selected by the investigator;
(i) determining which reasoning mode is associated with the higher quantity of terms selected by the investigator.;
(j) indicating to the investigator the reasoning mode associated with the higher quantity of terms selected by the investigator;
(k) providing descriptions of both reasoning modes to the investigator, whereby the investigator may consider the significance of the selections enabled by step g.

17. A method of associating terms with a reasoning mode, wherein each term includes descriptions of a quality or aspect of either a linear reasoning mode or a complexity reasoning mode, the method comprising:
a. Generating a list of terms defined as mental capacities;
b. Determining if each term is associated with a linear reasoning mode;
c. Determining if each term is associated with a complexity reasoning mode;
d. Identifying each term associated with the linear reasoning mode and not associated with the complexity reasoning mode as a linear reasoning capacity term; and
e. Identifying each term associated with the complexity reasoning mode and not associated with the linear reasoning mode as a complexity reasoning capacity term.

18. The method of claim 17, wherein at least one term of the list of terms describes a quality or aspect of relational positioning mapping.

19. The method of claim 17, wherein at least one term of the list of terms describes a quality or aspect of a homeodynamic diagnostic.

20. The method of claim 17, the method further comprising:
f. generating a first list of candidate first terms, the first list of candidate first terms comprising a plurality of candidate first terms, each candidate first term determined in step d as associated with the linear reasoning mode; and
g. generating a second list of candidate second terms, the second list of candidate second terms comprising a plurality of candidate second terms, each candidate second term determined in step e as associated with the complexity reasoning mode.

21. A method for determining when a complexity reasoning analysis or a linear reasoning analysis is more appropriate for analysis of a problem description, the method comprising;
a. Determining if the problem description matches any of a library of linear system descriptions;
b. Determining if the problem description matches at least one of a library of linear systems description and if the problem description is subject to a relationship of a subset or element of a system that matches at least one of a library of complexity system descriptions;
c. Determining if the problem description matches any of a library of complexity system descriptions;
d. Identifying a problem description matching at least one of a library of linear system descriptions, wherein the problem description is not subject to a relationship of an element or subset of complexity system description, as more appropriate for a linear reasoning analysis;
e. Identifying a problem description matching at least one of a library of linear system descriptions, wherein the problem description is subject to a relationship of an element or subset of a complexity system description, as more appropriate for a complexity reasoning analysis; and
f. Identifying a problem description matching at least one of a library of complexity system descriptions as more appropriate for a complexity reasoning analysis.

22. A method for determining the reasoning mode preference of an investigator, comprising:
a. providing the investigator with a combined plurality of terms comprising a plurality of complex adaptive system modeling terms and a plurality of linear system modeling terms;
b. asking the investigator to select terms from the combined plurality of terms that represent the assumptions that the investigator typically makes and/or the methods the investigator typically uses when trying to figure out a system;
c. receiving selected terms from the investigator; and
d. determining the relative quantities of selected terms from (i) the plurality of complex adaptive system modeling terms, and (ii.) the plurality of linear system modeling terms.
